(19) United States
(12) Patent Application Publication
(10) Pub. No.: US 2012/0081784 A1
(43) Pub. Date: Apr. 5, 2012

(54) PATTERNED RETARDER

(75) Inventor: Pavel Ivan LAZAREV, Menlo Park, CA (US)

(73) Assignee: Crysoptix KK, Tokyo (JP)

(21) Appl. No.: 13/249,165

(22) Filed: Sep. 29, 2011

Related U.S. Application Data
(60) Provisional application No. 61/389,207, filed on Oct. 2, 2010.

(51) Int. Cl. G02B 5/30; B05D 3/06; B05D 3/12; B05D 3/10; B05D 3/00; B05D 5/06; C23F 1/02

(52) U.S. Cl. 359/489.07; 427/162; 427/555; 216/24

(57) ABSTRACT

A patterned retarder includes at least one retardation plate comprising a substrate substantially transparent in visible spectral range and having front and rear surfaces and a set of parallel stripes located on front surface of the substrate and possessing in-plane retardation.

### FIELD OF THE INVENTION

The present invention relates generally to the field of organic chemistry and particularly to the optical retardation films particularly for application in 3D liquid crystal displays.

### BACKGROUND OF THE INVENTION

Generation of 3-dimensional effects based upon the projection of two different perspective images being viewed in the left and right eyes is known in prior art. Typically two images of the same object are prepared with a small change in the visual perspective of the image. These images are then viewed in such a manner that each eye of the observer only sees one of the images. The visual process then interprets two separate images as a single 3-dimensional image. This can be achieved in a variety of manners. Steroscopic viewers require the use of two distinct images which are viewed through two distinct optical paths. Composite images can be prepared by superimposing two separate images using two different coloured inks, e.g. red and blue. When viewed through a device containing suitable red and blue filters each eye only sees one of the component images and reconstructs the 3-D image. Two images can be projected onto a screen using polarized (linear or circular) light. Suitable viewing devices enable the viewer to reconstruct the 3-D image. Many devices are described as LCD shutter devices. These use liquid crystalline materials to provide a filter to each eye. The device is electronically controlled so that the shutters are activated sequentially. This allows the viewer to see the first image through the left eye and later the other image through the right eye.

The above described systems are expensive which is their main disadvantage on the market.

At present time the 3D displays currently available on the market are more expensive than standard LCD TVs. Therefore cost reduction of such TVs is a technological problem to be solved.

### SUMMARY OF THE INVENTION

In the first aspect, the present invention provides a patterned retarder comprising at least one retardation plate comprising a substrate substantially transparent in visible spectral range and having front and rear surfaces and a set of parallel stripes located on front surface of the substrate and possessing in-plane retardation.

In another aspect, the present invention provides a method of producing a patterned retardation plate, comprising the steps of a) preparation of a lyotropic liquid crystal solution of a composition comprising at least one organic compound of a first type, and/or at least one organic compound of a second type, wherein the organic compound of the first type has the general structural formula I

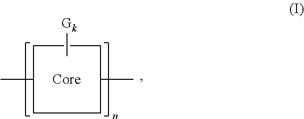

where Core is a conjugated organic unit capable of forming a rigid rod-like macromolecule, n is a number of the conjugated organic units in the rigid rod-like macromolecule, Gk is a set of ionogenic side-groups, and k is a number of the side-groups in the set Gk; wherein the ionogenic side-groups and the number k provide solubility of the organic compound of the first type in a solvent and give rigidity to the rod-like macromolecule; the number n provides molecule anisotropy that promotes self-assembling of macromolecules in a solution of the organic compound or its salt, and wherein the organic compound of the second type has the general structural formula II

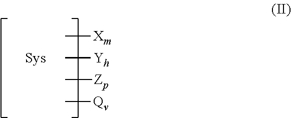

where Sys is an at least partially conjugated substantially planar polycyclic molecular system;
X, Y, Z, Q and R are substituents; substituent X is a carboxylic group —COOH, m is 0, 1, 2, 3 or 4; substituent Y is a sulfonic group —SO₃H, h is 0, 1, 2, 3 or 4; substituent Z is a carboxamide —CONH₂, p is 0, 1, 2, 3 or 4; substituent Q is a sulfonamide SO₂NH₂, v is 0, 1, 2, 3 or 4; wherein the organic compound of the second type is capable of forming board-like supramolecules via π-π-interaction, b) coating of a liquid layer of the solution onto a substrate, c) application of an external alignment action onto said liquid layer, d) drying to form a solid optical retardation layer, and e) forming of a set of parallel retardation stripes.

### BRIEF DESCRIPTION OF THE DRAWING

FIG. 1 schematically shows one embodiment of a retardation plate according to the present invention.

FIG. 2 schematically shows another embodiment of a retardation plate according to the present invention.

FIG. 3 schematically shows one embodiment of a patterned retarder according to the present invention.

FIGS. 4a and 4b schematically show another embodiment of a patterned retarder according to the present invention.

FIGS. 5a and 5b schematically show yet another embodiment of a patterned retarder according to the present invention.

### DETAILED DESCRIPTION OF THE INVENTION

The general description of the present invention having been made, a further understanding can be obtained by reference to the specific preferred embodiments, which are given herein only for the purpose of illustration and are not intended to limit the scope of the appended claims.

Definitions of various terms used in the description and claims of the present invention are listed below.

The term “visible spectral range” refers to a spectral range having the lower boundary approximately equal to 400 nm, and upper boundary approximately equal to 700 nm.

The term “retardation layer” refers to an optically anisotropic layer which is characterized by three principal refractive indices (nₓ, n_{y} and n_{z}), wherein two principal directions for refractive indices nₓ and n_{y} belong to xy-plane coinciding with a plane of the retardation layer and one principal direction for refractive index (n_{z}) coincides with a normal line to the retardation layer.

The term “optically anisotropic retardation layer of A_{C}-type” refers to an optical layer which principal refractive indices nₓ, n_{y}, and n_{z} obey the following condition in the visible spectral range: n_{z}<n_{y}<nₓ.

The term “optically anisotropic retardation layer of B_{A}-type” refers to an optical layer which principal refractive indices nₓ, n_{y}, and n_{z} obey the following condition in the visible spectral range: nₓ<n_{z}<n_{y}.

The term “optically anisotropic retardation layer of positive A-type” refers to an uniaxial optic layer which principal refractive indices nₓ, n_{y}, and n_{z} obey the following condition in the visible spectral range: n_{z}=n_{y}<nₓ.

The term “optically anisotropic retardation layer of negative A-type” refers to an uniaxial optic layer which principal refractive indices nₓ, n_{y}, and n_{z} obey the following condition in the visible spectral range: n_{z}=n_{y}>nₓ.

The above mentioned definitions are invariant to rotation of system of coordinates (of the laboratory frame) around of the vertical z-axis for all types of anisotropic layers.

The present invention provides a patterned retarder as disclosed hereinabove.

In one embodiment of a patterned retarder, the stripes possess B_{A}-type retardation and characterized by two principal refractive indices (nₓ and n_{y}) corresponding to two mutually perpendicular directions in the plane of the stripes and one principal refractive index (n_{z}) in the normal direction to the stripes, which satisfy the following condition: nₓ<n_{z}<n_{y}. In another embodiment of a patterned retarder, the fast optical axis corresponding to the principal refractive index nₓ is directed in a parallel way with respect to stripes. In yet another embodiment of a patterned retarder, the fast optical axis corresponding to the principal refractive index nₓ is directed perpendicularly with respect to stripes. In still another embodiment of a patterned retarder, the fast optical axis corresponding to the principal refractive index nₓ is directed at 45 degrees in respect to the stripes.

In one embodiment of a patterned retarder, the stripes possess negative A-type retardation and characterized by two principal refractive indices (nₓ and n_{y}) corresponding to two mutually perpendicular directions in the plane of the retardation layer and one principal refractive index (n_{z}) in the normal direction to the retardation layer, which satisfy the following condition: nₓ<n_{y}=n_{z}. In another embodiment of a patterned retarder, the fast optical axis corresponding to the principal refractive index nₓ is directed in a parallel way with respect to the stripes. In yet another embodiment of a patterned retarder, the fast optical axis corresponding to the principal refractive index nₓ is directed perpendicularly with respect to the stripes. In still another embodiment of a patterned retarder according to claim 6, wherein the fast optical axis corresponding to the principal refractive index nₓ is directed at 45 degrees in respect to the stripes.

In one embodiment of a patterned retarder, the stripes possess positive A-type retardation and are characterized by two principal refractive indices (nₓ and n_{y}) corresponding to two mutually perpendicular directions in the plane of the retardation layer and one principal refractive index (n_{z}) in the normal direction to the retardation layer, which satisfy the following condition: nₓ>n_{y}=n_{z}. In another embodiment of a patterned retarder, the slow optical axis corresponding to the principal refractive index nₓ is directed in a parallel way with respect to the stripes. In yet another embodiment of a patterned retarder, the slow optical axis corresponding to the principal refractive index nₓ is directed perpendicularly with respect to the stripes. In still another embodiment of a patterned retarder, the slow optical axis corresponding to the principal refractive index nₓ is directed at 45 degrees in respect to the stripes.

In one embodiment of a patterned retarder, the stripes possess Ac-type retardation and characterized by two principal refractive indices (nₓ and n_{y}) corresponding to two mutually perpendicular directions in the plane of the stripes and one principal refractive index (n_{z}) in the normal direction to the stripes, which satisfy the following condition: n_{z}<n_{y}<nₓ. In another embodiment of a patterned retarder, the slow optical axis corresponding to the principal refractive index nₓ is directed in a parallel way with respect to the stripes. In yet another embodiment of a patterned retarder, the slow optical axis corresponding to the principal refractive index nₓ is directed is directed perpendicularly with respect to the stripes. In still another embodiment of a patterned retarder, the slow optical axis corresponding to the principal refractive index nₓ is directed at 45 degrees in respect to the stripes.

In one embodiment of a patterned retarder, the stripes further comprise at least one organic compound of a first type or its salt, and/or at least one organic compound of a second type. The organic compound of the first type has the general structural formula I

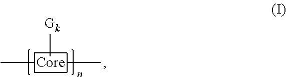

where Core is a conjugated organic unit capable of forming a rigid rod-like macromolecule, n is a number of the conjugated organic units in the rigid rod-like macromolecule which is equal to integers in the range from 10 to 10000, Gₖ is a set of ionogenic side-groups, and k is a number of the side-groups in the set Gₖ, k is a number of the side-groups in the set Gₖ₁ which is equal to 0, 1, 2, 3, 4, 5, 6, 7, or 8. The organic compound of the second type has the general structural formula II

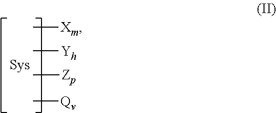

where Sys is an at least partially conjugated substantially planar polycyclic molecular system; X, Y, Z, Q and R are substituents; substituent X is a carboxylic group —COOH, m is 0, 1, 2, 3 or 4; substituent Y is a sulfonic group —SO₃H, h is 0, 1, 2, 3 or 4; substituent Z is a carboxamide —CONH₂, p is 0, 1, 2, 3 or 4; substituent Q is a sulfonamide —SO₂NH₂, v is 0, 1, 2, 3 or 4. The organic compound of the second type forms board-like supramolecules via π-π-interaction, and a composition comprising the compounds of the first and the second types forms lyotropic liquid crystal in a solution with a suitable solvent.

In another embodiment of a patterned retarder, the organic compound of the first type is selected from the structures 1 to 20 shown in Table 1.

TABLE 1
Examples of the structural formulas of the organic compounds of the first
type according to the present invention

| | |
|---|---|
| 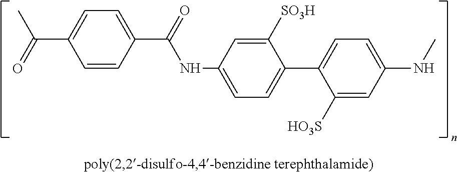 | (1) |
| 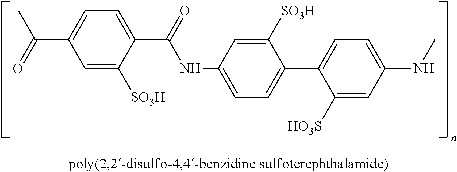 | (2) |
| 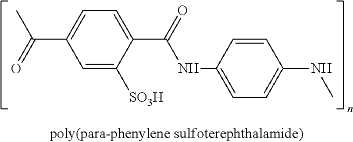 | (3) |
| 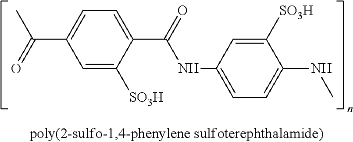 | (4) |
| 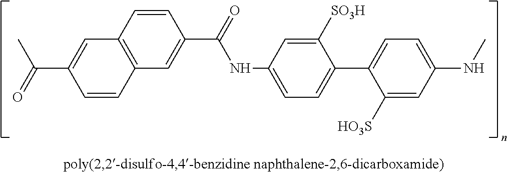 | (5) |
| 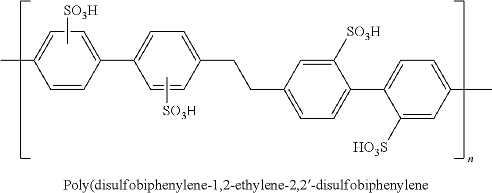 | (6) |
| 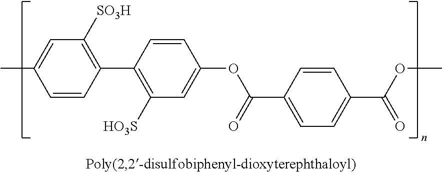 | (7) |
| 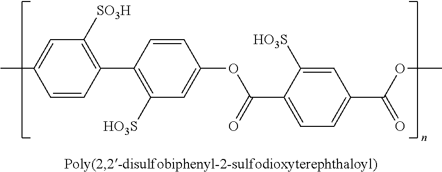 | (8) |
| 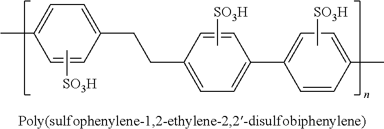 | (9) |
| 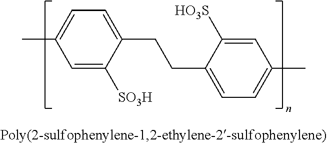 | (10) |
| 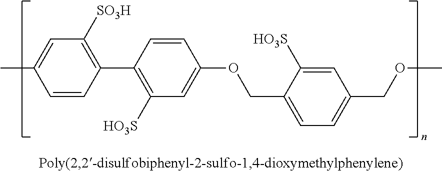 | (11) |
| 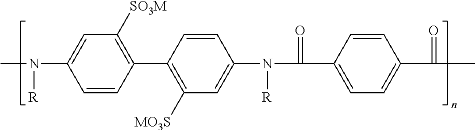 | (12) |
| 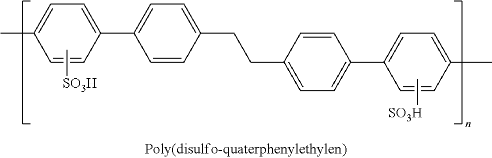 | (13) |
| 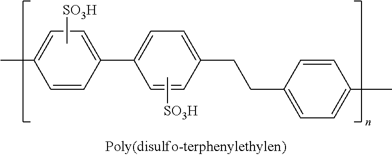 | (14) |
| 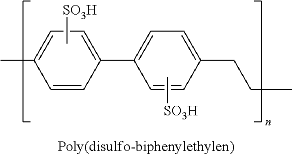 | (15) |
| 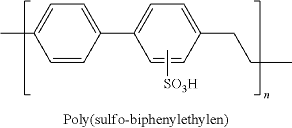 | (16) |
| 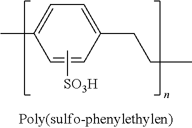 | (17) |
| 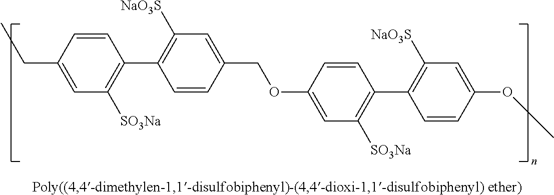 | (18) |
| 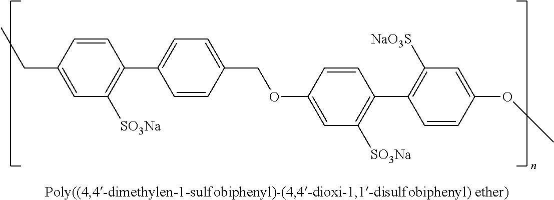 | (19) |
| 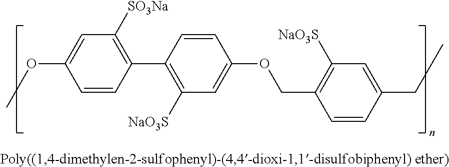 | (20) |

where R is a side-group selected from the list comprising Alkil, (CH₂)ₘSO₃H, (CH₂)ₘSi(O Alkyl)₃, CH₂-Phenyl, (CH₂)ₘOH and M is counterion selected from the list comprising H⁺, Na⁺, K⁺, Li⁺, Cs⁺, Ba²⁺, Ca²⁺, Mg²⁺, Sr²⁺, Pb²⁺, Zn²⁺, La³⁺, Ce³⁺, Y³⁺, Yb³⁺, Gd³⁺, Zr⁴⁺ and NH₄₋ₖQₖ⁺, where Q is selected from the list comprising linear and branched (C1-C20) alkyl, (C2-C20) alkenyl, (C2-C20) alkinyl, and (C6-C20)arylalkyl, and k is 0, 1, 2, 3 or 4.

In another embodiment of a patterned retarder, the organic compound of the first type further comprises additional side-groups independently selected from the list comprising linear and branched (C₁-C₂₀)alkyl, (C₂-C₂₀)alkenyl, and (C₂-C₂₀)alkinyl. In yet another embodiment of a patterned retarder, at least one of the additional side-groups is connected with the conjugated organic unit Core via a bridging group A selected from the list comprising —C(O)—, —C(O)O—, —C(O)—NH—, —(SO₂)NH—, —O—, —CH₂O—, —NH—, >N—, and any combination thereof. In still another embodiment of a patterned retarder, the salt of the organic compound of the first type is selected from the list comprising ammonium and alkali-metal salts.

In one embodiment of a patterned retarder, the organic compound of the second type has at least partially conjugated substantially planar polycyclic molecular system Sys selected from the structures of the general formulas 21 to 34 shown in Table 2.

TABLE 2
Examples of at least partially conjugated substantially planar polycyclic
molecular systems Sys

| | |
|---|---|
| 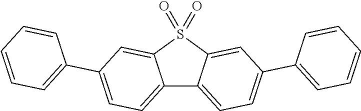 | (21) |
| 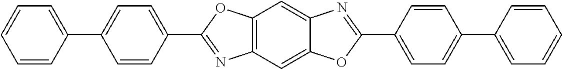 | (22) |
| 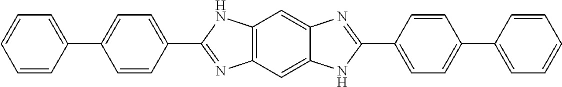 | (23) |
| 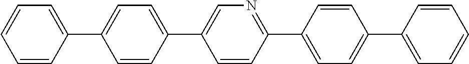 | (24) |
| 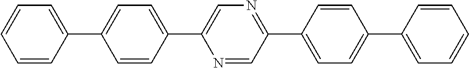 | (25) |
| 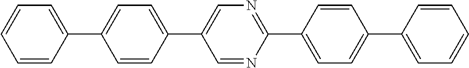 | (26) |
| 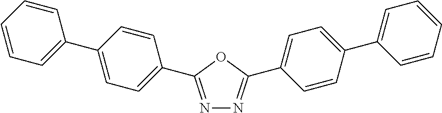 | (27) |
| 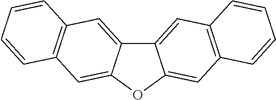 | (28) |
| 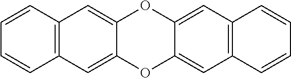 | (29) |
| 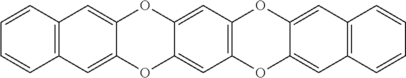 | (30) |
| 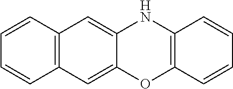 | (31) |
| 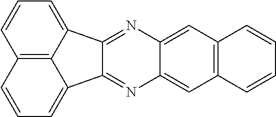 | (32) |
| 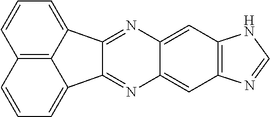 | (33) |
| 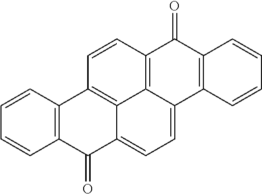 | (34) |

In another embodiment of a patterned retarder, the organic compound of the second type is selected from structures 35 to 43 shown in Table 3, where the molecular system Sys is selected from the structures 21 and 28 to 34, the substituent is a sulfonic group —SO₃H, and m1, p1, and v1 are equal to 0.

TABLE 3
Examples of the structural formulas of the organic compounds of the
second type according to the present invention

| | |
|---|---|
| 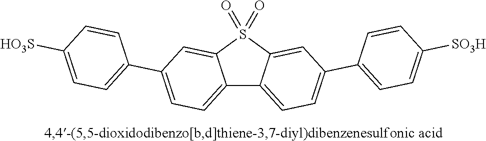 | (35) |
| 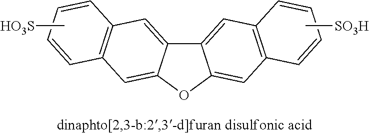 | (36) |
| 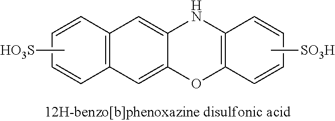 | (37) |
| 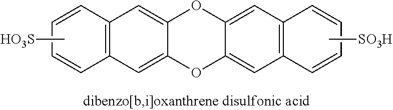 | (38) |
| 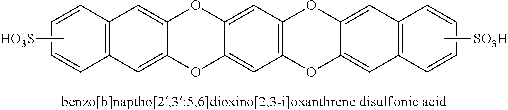 | (39) |
| 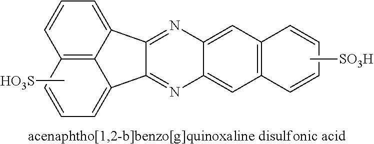 | (40) |
| 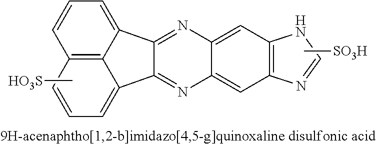 | (41) |
| 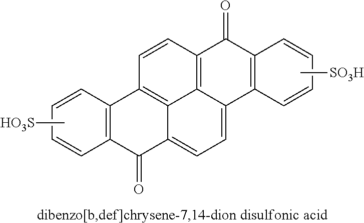 | (42) |
| 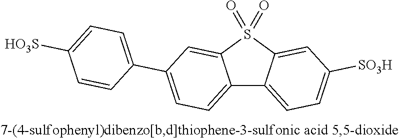 | |

In yet another embodiment of a patterned retarder, the organic compound of the second type further comprises at least one substituent selected from the list comprising CH₃, C₂H₅, Cl, Br, NO₂, F, CF₃, CN, OH, OCH₃, OC₂H₅, OCOCH₃, OCN, SCN, and NHCOCH₃.

In one embodiment of a patterned retarder, the substrate is made of a polymer. In another embodiment of a patterned retarder, the substrate is made of a glass. In yet another embodiment of a patterned retardation plate, the substrate is made of a birefringent material substantially transparent to electromagnetic radiation in the visible spectral range and possesses an anisotropic property of a positive A-type retarder.

In still another embodiment of a patterned retarder, the birefringent material is selected from the list comprising poly ethylene terephtalate (PET), poly ethylene naphtalate (PEN), polyvinyl chloride (PVC), polycarbonate (PC), poly propylene (PP), poly ethylene (PE), polyimide (PI), and poly ester. In one embodiment of the present invention, a patterned retarder further comprises planarization layer located on top of the set of the stripes. In another embodiment of the present invention, a patterned retarder further comprises an additional transparent adhesive layer.

In one embodiment of the present invention, a patterned retarder further comprises a retardation panel.

In one embodiment of a patterned retarder, the retardation panel comprises a panel substrate substantially transparent in visible spectral range and having front and rear surfaces and a panel retardation layer located on the front surface of the panel substrate, wherein the retardation plate is located on the panel retardation layer so that the front surface of the panel substrate is facing the front surface of the substrate of the retardation plate. In another embodiment of a patterned retarder, the panel retardation layer further comprise at least one organic compound of a first type or its salt, wherein the organic compound of the first type has the general structural formula I

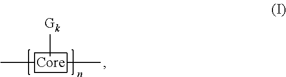

where Core is a conjugated organic unit capable of forming a rigid rod-like macromolecule,
n is a number of the conjugated organic units in the rigid rod-like macromolecule which is equal to integers in the range from 10 to 10000, Gₖ is a set of ionogenic side-groups, and k is a number of the side-groups in the set Gₖ, k is a number of the side-groups in the set Gₖ₁ which is equal to 0, 1, 2, 3, 4, 5, 6, 7, or 8; and/or at least one organic compound of a second type, wherein the organic compound of the second type has the general structural formula II

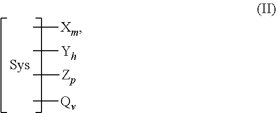

where Sys is an at least partially conjugated substantially planar polycyclic molecular system; X, Y, Z, Q and R are substituents; substituent X is a carboxylic group —COOH, m is 0, 1, 2, 3 or 4; substituent Y is a sulfonic group —SO₃H, h is 0, 1, 2, 3 or 4; substituent Z is a carboxamide —CONH₂, p is 0, 1, 2, 3 or 4; substituent Q is a sulfonamide —SO₂NH₂, v is 0, 1, 2, 3 or 4;
wherein the organic compound of the second type forms board-like supramolecules via π-π-interaction, and a composition comprising the compounds of the first and the second types forms lyotropic liquid crystal in a solution with a suitable solvent. In another embodiment of a patterned retarder, the stripes of the retardation plate possess in-plane retardation equal to λ/2 and the additional retardation panel possesses in-plane retardation equal to λ/4, where λ is central wave-length of a working wave-band.

In another embodiment of the present invention, a patterned retarder comprises two retardation plates. The first retardation plate comprises a first substrate having a front surface and a rear surface and the second retardation plate comprises a second substrate having a front surface and a rear surface. The first retardation plate comprises a first set of parallel stripes located on the front surface of the first substrate and the second retardation plate comprises a second set of parallel stripes located on the front surface of the second substrate. The first retardation plate is located on the second retardation plate so that the front surface of the first substrate is faced to the front surface of the second substrate. The stripes of the first set are located between the stripes of the second set and the stripes of both sets are mostly parallel to each other. In yet another embodiment of a patterned retarder, the in-plane retardation of the stripes of the first retardation plate and the in-plane retardation of the stripes of the second retardation plate are equal to λ/4, where λ is central wave-length of a working wave-band, wherein the fast optical axis of the first retardation plate is directed perpendicularly with respect to the fast optical axis of the second retardation plate, and wherein the optical axes are located in the plane of the stripes. In still another embodiment of a combined patterned retarder, the in-plane retardations of the first patterned retardation plate is equals to λ/4 and the in-plane retardations of the second patterned retardation plate is equals to 3λ/4, where λ is central wave-length of a working wave-band.

The present invention also provides a method of producing a patterned retardation plate as disclosed hereinabove. In one embodiment of the method, the forming of the set of parallel retardation stripes is carried out by different methods selected from the list comprising skiving, plasma-assisted etching and laser ablation method. In another embodiment of the present invention, the disclosed method further comprises a post-treatment step comprising a treatment with a solution of any inorganic salt with a cation selected from the list comprising H⁺, Ba²⁺, Pb²⁺, Ca²⁺, Mg²⁺, Sr²⁺, La³⁺, Zn²⁺, Zr⁴⁺, Ce³⁺, Y³⁺, Yb³⁺, Gd³⁺ and any combination thereof soluble in water or any solvent mixable with water. In another embodiment of the disclosed method, the application of an external alignment action c) and the forming of the set of parallel retardation stripes e) are carried out simultaneously. In yet another embodiment of the method, the drying d) and the forming of the set of parallel retardation stripes e) are carried out sequentially. In still another embodiment of the method, the external alignment action is directed in a parallel way with respect to the retardation stripes. In one embodiment of the method, the external alignment action is directed perpendicularly with respect to the retardation stripes.

In another embodiment of the method, the organic compound of the first type is selected from the structures 1 to 20 shown in Table 1. In yet another embodiment of the method, the organic compound of the first type further comprises additional side-groups independently selected from the list comprising linear and branched (C1-C20)alkyl, (C₂-C₂₀)alkenyl, and (C2-C20)alkinyl. In still another embodiment of the method, at least one of the additional side-groups is connected with the conjugated organic unit Core via a bridging group A selected from the list comprising —C(O)—, —C(O)O—, —C(O)—NH—, —(SO₂)NH—, —O—, —CH₂O—, —NH—, >N—, and any combination thereof. In one embodiment of the method, the salt of the organic compound of the first type is selected from the list comprising ammonium and alkali-metal salts.

In another embodiment of the method, the organic compound of the second type has at least partially conjugated substantially planar polycyclic molecular system Sys selected from the structures 21 to 34 shown in Table 2. In yet another embodiment of the method, the organic compound of the second type is selected from structures 35 to 43 shown in Table 3, where the molecular system Sys is selected from the structures 21 and 28 to 34, the substituent is a sulfonic group —SO₃H, and m1, p1, and v1, are equal to 0. In one embodiment of the method, the organic compound of the second type further comprises at least one substituent selected from the list comprising CH₃, C₂H₅, Cl, Br, NO₂, F, CF₃, CN, OH, OCH₃, OC₂H₅, OCOCH₃, OCN, SCN, and NHCOCH₃.

In one embodiment of the method, the stripes possess B_{A}-type retardation and are characterized by two principal refractive indices (nₓ and n_{y}) corresponding to two mutually perpendicular directions in the plane of the stripes and one principal refractive index (n_{z}) in the normal direction to the stripes, which satisfy the following condition: nₓ<n_{z}<n_{y}. In another embodiment of the method, the stripes possess negative A-type retardation and characterized by two principal refractive indices (nₓ and n_{y}) corresponding to two mutually perpendicular directions in the plane of the retardation layer and one principal refractive index (n_{z}) in the normal direction to the retardation layer, which satisfy the following condition: nₓ<n_{y}=n_{z}. In yet another embodiment of the method, wherein the stripes possess B_{A}-type or negative A-type retardation, the fast optical axis corresponding to the principal refractive index nₓ coincides with coating direction.

In one embodiment of the method, the stripes possess Ac-type retardation and characterized by two principal refractive indices (nₓ and n_{y}) corresponding to two mutually perpendicular directions in the plane of the stripes and one principal refractive index (n_{z}) in the normal direction to the stripes, which satisfy the following condition: n_{z}<n_{y}<nₓ. In another embodiment of the method, the stripes possess positive A-type retardation and characterized by two principal refractive indices (nₓ and n_{y}) corresponding to two mutually perpendicular directions in the plane of the retardation layer and one principal refractive index (n_{z}) in the normal direction to the retardation layer, which satisfy the following condition: nₓ>n_{y}=n_{z}. In yet another embodiment of the method, wherein the stripes possess Ac-type or positive A-type retardation, the slow optical axis corresponding to the principal refractive index nₓ coincides with coating direction.

Reference will now be made to the Figures in which the various elements of the present invention will be given numerical designations and in which the invention will be discussed so as to enable one skilled in the art to make and use the invention. It is to be understood that elements not specifically shown or described may take various forms well known to those skilled in the art.

FIG. 1 schematically shows a retardation plate according one embodiment of the present invention. This retardation plate comprises a set of parallel stripes (1) coated on a substrate (2). The stripes possess positive A-type retardation and characterized by in-plane retardation equal to λ/2 and the substrate possess positive A-type retardation also and characterized by in-plane retardation equal to λ/4. The slow optical axes of the substrate (3) and stripes (4) mostly parallel to each other. The stripes (1) are made in parallel to coating direction (5). This retardation plate is intended for circular polarizer for 3D LCD. The retardation plate is attached to LCD front polarizer with slow optical axis at 45 degree to polarizer absorption axis. In this case the manufacturing process is: 1) roll of polarizer is cut in diagonal pieces with ˜30% losses (standard process); 2) roll of retarder is made with stripes in parallel to roll axis; 3) roll of retarder is cut in rectangular pieces without losses; 4) sheets of retarder are laminated to polarizer sheets.

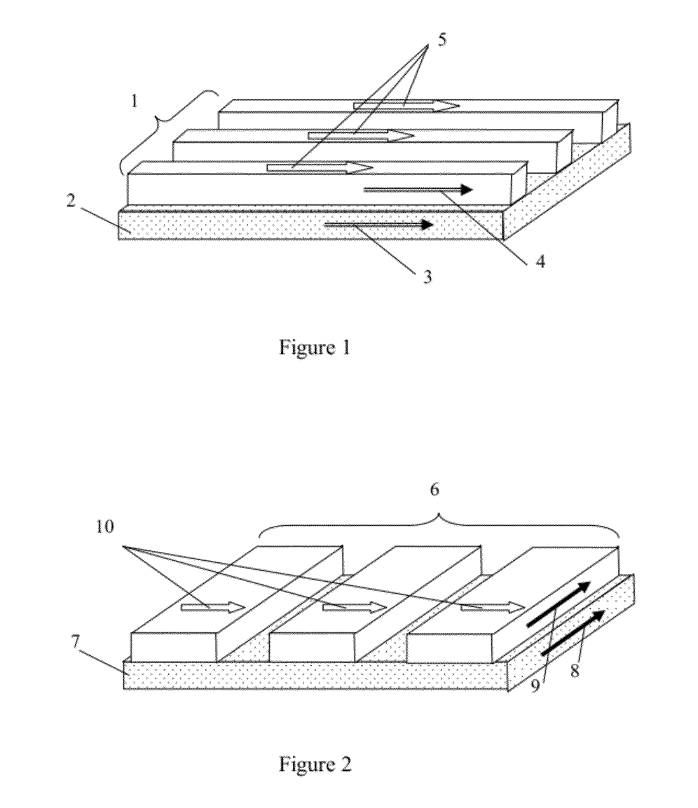

FIG. 2 schematically shows a retardation plate according another embodiment of the present invention. This retardation plate comprises a set of parallel stripes (6) coated on a substrate (7). The stripes possess B_{A}-type retardation and characterized by in-plane retardation equal to λ/2 and the substrate possess positive A-type retardation and characterized by in-plane retardation equal to λ/4. The fast optical axes of the substrate (8) and stripes (9) mostly parallel to each other. The stripes (6) are made perpendicular to coating direction (10). This retardation plate is intended for circular polarizer for 3D LCD. The retardation plate is attached to LCD front polarizer with slow optical axis at 45 degree to polarizer absorption axis.

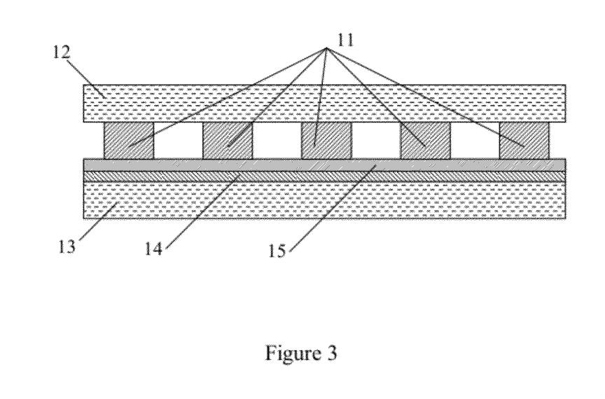

FIG. 3 schematically shows a patterned retarder according yet another embodiment of the present invention. This patterned retarder comprises a set of the parallel stripes (11) coated on a substrate (12) made of TAC or glass. The stripes possess positive A-type retardation and are characterized by in-plane retardation equal to λ/2. The patterned retarder comprises a retardation layer (14) located on a substrate (13) made of TAC or glass. The retardation layer (14) possesses positive A-type retardation and is characterized by in-plane retardation equal to λ/4. The stripes and the retardation layer are glued together with an adhesive layer (15). The slow optical axes of the substrate (12) and the stripes (11) are substantially parallel to each other. This patterned retardation plate can be used as a circular polarizer for 3D LCD. The patterned retarder is attached to the LCD front polarizer with slow optical axis at 45 degree to a polarizer absorption axis. In still another embodiment of the present invention, the stripes (11) and the retardation layer (14) possess positive B_{A}-type retardation.

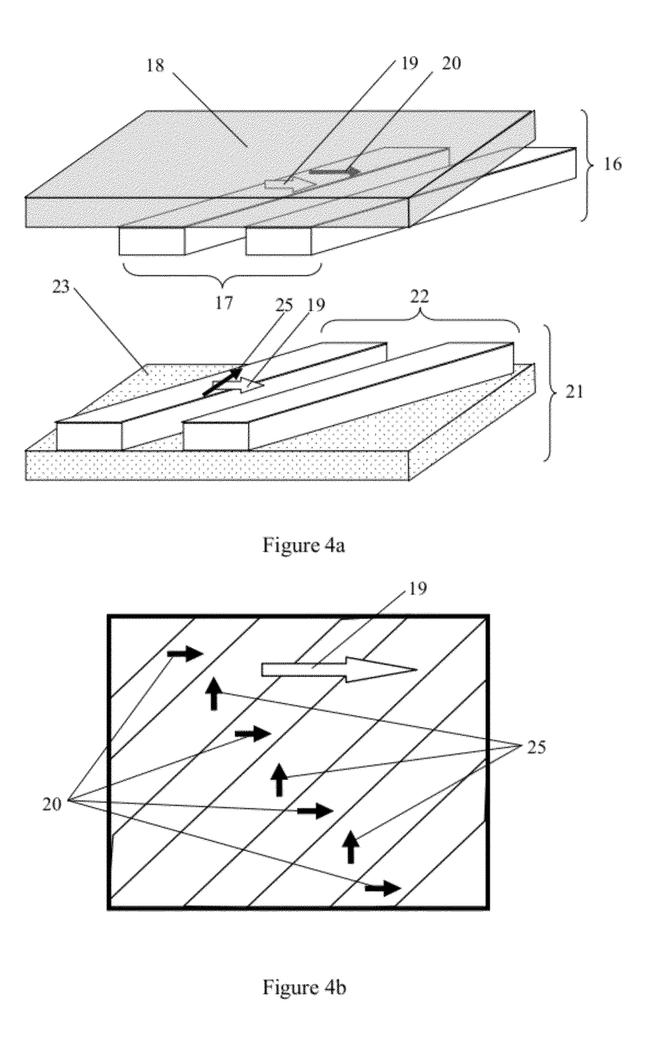

FIGS. 4a and 4b schematically show a patterned retarder according to another embodiment of the present invention. This patterned retarder comprises a first retardation plate (16) having a set of parallel stripes (17) coated on a substrate (18) made of TAC or glass. The stripes possess positive A-type retardation and are characterized by in-plane retardation equal to λ/4. These stripes are directed at 45 degree to coating direction (19). The slow optical axes (20) of the stripes (17) and coating direction (19) are substantially parallel to each other. The patterned retarder comprises a second retardation plate (21) having a set of parallel stripes (22) coated on a substrate (23) made of TAC or glass. The stripes possess positive A-type retardation and are characterized by in-plane retardation equal to λ/4. These stripes are made at 45 degree to coating direction (19). The slow optical axes (25) of the stripes (22) and coating direction (19) are substantially perpendicular to each other. The first (16) and second (21) retardation plates are glued with the adhesive layer (not shown in FIG. 4a). FIG. 4b shows the top view of the same embodiment.

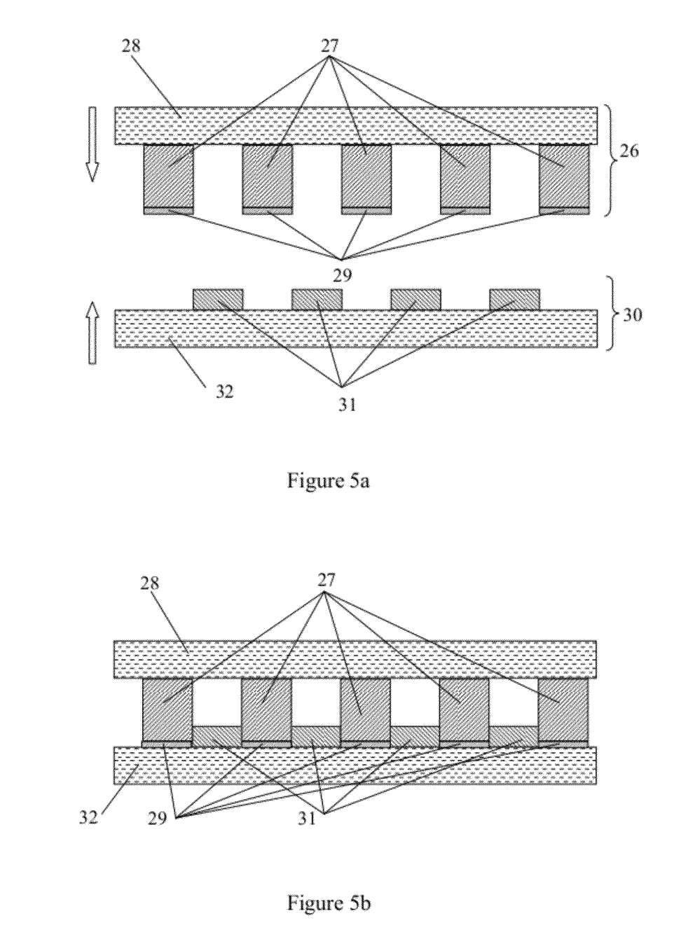

FIGS. 5a and 5b schematically show a patterned retarder according to another embodiment of the present invention. The patterned retarder comprises a first retardation plate (26) having a set of parallel stripes (27) coated on a substrate (28) made of TAC or glass. The stripes possess positive A-type retardation and are characterized by in-plane retardation equal to 3λ/4. These stripes are covered with the adhesive stripes (29). The patterned retarder comprises a second retardation plate (30) having a set of parallel stripes (31) coated on a substrate (32) made of TAC or glass. The stripes possess positive A-type retardation and are characterized by in-plane retardation equal to λ/4. The first (16) and second (21) retardation plates are glued together with the adhesive stripes (29). FIG. 5b schematically shows a final design of the disclosed patterned retarder.

In order that the invention may be more readily understood, reference is made to the following examples, which are intended to be illustrative of the invention, but are not intended to be limiting the scope.

### EXAMPLES

### Example 1

This Example describes synthesis of poly(2,2′-disulfo-4,4′-benzidine terephthalamide) cesium salt (structure 1 in Table 1).

1.377 g (0.004 mol) of 4,4′-diaminobiphenyl-2,2′-disulfonic acid was mixed with 1.2 g (0.008 mol) of Cesium hydroxide and 40 ml of water and stirred with dispersing stirrer till dissolution. 0.672 g (0.008 mol) of sodium bicarbonate was added to the solution and stirred. While stirring the obtained solution at a high speed (2500 rpm) the solution of 0.812 g (0.004 mol) of terephthaloyl dichloride in dried toluene (15 mL) was gradually added within 5 minutes. The stirring was continued for 5 more minutes, and viscous white emulsion was formed. Then the emulsion was diluted with 40 ml of water, and the stirring speed was reduced to 100 rpm. After the reaction mass has been homogenized the polymer was precipitated via adding 250 ml of acetone. Fibrous sediment was filtered and dried.

Gel permeation chromatography (GPC) analysis of the sample was performed with Hewlett Packard 1050 chromatograph with diode array detector (λ=230 nm), using Varian GPC software Cirrus 3.2 and TOSOH Bioscience TSKgel G5000 PW_{XL} column and 0.2 M phosphate buffer (pH=7) as the mobile phase. Poly(para-styrenesulfonic acid) sodium salt was used as a GPC standard. The number average molecular weight Mn, weight average molecular weight Mw, and polydispersity P were found as 3.9×10⁵, 1.7×10⁶, and 4.4 respectively.

### Example 2

This Example describes synthesis of poly(2,2′-disulfo-4,4′-benzidine sulfoterephthalamide) (structure 2 in Table 1).

10 g (40 mmol) of 2-sulfoterephtalic acid, 27.5 g (88.7 mmol) of triphenylphosphine, 20 g of Lithium chloride and 50 ml of pyridine were dissolved in 200 ml of N-methylpyrrolidone in a 500 ml three-necked flask. The mixture was stirred at 40° C. for 15 min and then 13.77 g (40 mmol) of 4,4′-diaminobiphenyl-2,2′-disulfonic acid were added. The reaction mixture was stirred at 115° C. for 3 hours. 1 L of methanol was added to the viscous solution, formed yellow precipitate was filtrated and washed sequentially with methanol (500 ml) and diethyl ether (500 ml). Yellowish solid was dried in vacuo at 80° C. overnight. Molecular weight analysis of the sample via GPC was performed as described in Example 1.

### Example 3

This Example describes synthesis of poly(para-phenylene sulfoterephthalamide) (structure 3 in Table 1).

10 g (40 mmol) of 2-sulfoterephtalic acid, 27.5 g (88.7 mmol) of triphenylphosphine, 20 g of lithium chloride and 50 ml of pyridine were dissolved in 200 ml of N-methylpyrrolidone in a 500 ml three-necked flask. The mixture was stirred at 40° C. for 15 min and then 4.35 g (40 mmol) of 1,4-phenylenediamine were added. The reaction mixture was stirred at 115° C. for 3 hours. 1 L of methanol was added to the viscous solution, formed yellow precipitate was filtrated and washed sequentially with methanol (500 ml) and diethyl ether (500 ml). Yellowish solid was dried in vacuo at 80° C. overnight. Molecular weight analysis of the sample via GPC was performed as described in Example 1.

### Example 4

This Example describes synthesis of poly(2-sulfo-1,4-phenylene sulfoterephthalamide) (structure 4 in Table 1).

10 g (40 mmol) of 2-sulfoterephtalic acid, 27.5 g (88.7 mmol) of triphenylphosphine, 20 g of Lithium chloride and 50 ml of pyridine were dissolved in 200 ml of N-methylpyrrolidone in a 500 ml three-necked flask. The mixture was stirred at 40° C. for 15 min and then 7.52 g (40 mmol) of 2-sulfo-1,4-phenylenediamine were added. The reaction mixture was stirred at 115° C. for 3 hours. 1 L of methanol was added to the viscous solution, formed yellow precipitate was filtrated and washed sequentially with methanol (500 ml) and diethyl ether (500 ml). Yellowish solid was dried in vacuo at 80° C. overnight. Molecular weight analysis of the sample via GPC was performed as described in Example 1.

### Example 5

This Example describes synthesis of poly(2,2′-disulfo-4,4′-benzidine naphthalene-2,6-dicarboxamide) cesium salt (structure 5 in Table 1).

0.344 g (0.001 mol) of 4,4′-diaminobiphenyl-2,2′-disulfonic acid was mixed with 0.3 g (0.002 mol) of Cesium hydroxide and 10 ml of water and stirred with dispersing stirrer till dissolution. 0.168 g (0.002 mol) of sodium bicarbonate was added to the solution and stirred. While stirring the obtained solution at a high speed (2500 rpm) the solution of 0.203 g (0.001 mol) of terephthaloyl dichloride in dried toluene (4 mL) was gradually added within 5 minutes. The stirring was continued for 5 more minutes, and viscous white emulsion was formed. Then the emulsion was diluted with 10 ml of water, and the stirring speed was reduced to 100 rpm. After the reaction mass has been homogenized the polymer was precipitated via adding 60 ml of acetone. The fibrous sediment was filtered and dried. Molecular weight analysis of the sample via GPC was performed as described in Example 1.

### Example 6

This Example describes synthesis of 4,4′-(5,5-dioxidodibenzo[b,d]thiene-3,7-diyl)dibenzenesulfonic acid (structure 32 in Table 3).

1,1′:4′,1″:4″,1′″-quarerphenyl (10 g) was charged into 0%-20% oleum (100 ml). Reaction mass was agitated for 5 hours at heating to 50° C. After that the reaction mixture was diluted with water (170 ml). The final sulfuric acid concentration became approximately 55%. The precipitate was filtered and rinsed with glacial acetic acid (˜200 ml). The filter cake was dried in an oven at 110° C.

HPLC analysis of the sample was performed with Hewlett Packard 1050 chromatograph with diode array detector (λ=310 nm), using Reprosil™ Gold C8 column and linear gradient elution with acetonitrile/0.4 M ammonium acetate (pH=3.5 acetic acid) aqueous solution.

### Example 7

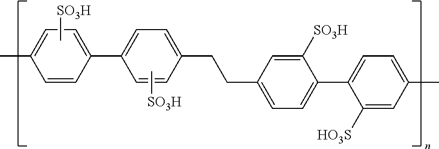

This example describes synthesis of Poly(disulfobiphenylene-1,2-ethylene-2,2′-disulfobiphenylene) (structure 6 in Table 1).

36 g of finely ground Bibenzyl in a Petri dish is set on a porcelain rack in a desiccator with an evaporating dish under the rack containing 80 g of Bromine The desiccator is closed but a very small opening is provided for the escape of hydrogen bromide. The bibenzyl is left in contact with the bromine vapors for overnight. Then the dish with bromine is removed from the desiccator and the excess of bromine vapors evacuated by water pump. The orange solid is then recrystallized from 450 ml of isopropyl alcohol. The yield of 4,4′-dibromobibenzyl is 20 g.

A 5.4 ml of 2.5 M solution of butyllithium in hexane is added dropwise at −78° C. to a stirred solution of 3 g of 4,4′-dibromobibenzyl in 100 ml of dry tetrahydrofuran under argon. The mixture is stirred at this temperature for 6 hrs to give a white suspension. 6 ml of triisopropylborate is added, and the mixture is stirred overnight allowing the temperature to rise to room temperature. 30 ml of water is added, and the mixture stirred at room temperature for 4 hours. The organic solvents are removed on a rotavapor (35° C., 40 mbar), then 110 ml of water is added, and the mixture is acidified with concentrated HCl. The product is extracted into diethyl ether (7×30 ml), the organic layer was dried over magnesium sulfate, and the solvent was removed with a rotavapor. The residue is dissolved in 11 ml of Acetone and reprecipitated into a mixture of 13 ml of water and 7 ml of concentrated hydrochloric acid. The yield of dipropyleneglycol ester of bibenzyl 4,4′-diboronic acid is 2.4 g.

100 g of 4,4′-Diamino-2,2′-biphenyldisulfonic acid, 23.2 g of sodium hydroxide and 3500 ml of water are mixed and cooled to 0-5° C. A solution of 41 g of sodium nitrite in 300 ml of water is added, the solution is stirred for 5 min and then 100 ml of 6M hydrochloric acid is added. A pre-cooled solution of 71.4 g of potassium bromide in 300 ml of water is added to the resulting dark yellow solution in 2 ml portions. After all the potassium bromide has been added the solution is allowed to warm up to room temperate. Then the reaction mixture is heated and held at 90° C. for 16 hours. A solution of 70 g of sodium hydroxide in 300 ml of water is added, the solution evaporated to a total volume of 400 ml, diluted with 2500 ml of methanol to precipitate the inorganic salts and filtered. The methanol is evaporated to 20-30 ml and 3000 ml of isopropanol is added. The precipitate is washed with methanol on the filter and recrystallized from methanol. Yield of 4,4′-dibromo-2,2′-biphenyldisulfonic acid is 10.7 g.

The polymerization is carried out under nitrogen. 2.7 g of 4,4′-Dihydroxy-2,2′-biphenyldisulfonic acid and 2.0 g of dipropyleneglycol ester of bibenzyl 4,4′-diboronic acid are dissolved in a mixture of 2.8 g of sodium hydrocarbonate, 28.5 ml of tetrahydrofuran and 17 ml of water. Tetrakis(triphenylphosphine)palladium(0) is added (5×10⁻³ molar equivalent compared to dipropyleneglycol ester of bibenzyl 4,4′-diboronic acid). The resulting suspension is stirred for 20 hrs. 0.04 g of bromobenzene is then added. After two hours the polymer is precipitated by pouring it into 150 ml of ethanol. The product is washed with water, dried, and dissolved in toluene. The filtered solution is concentrated and the polymer precipitated in a 5-fold excess of ethanol and dried. The yield of polymer is 2.7 g.

8.8 g of 95% sulfuric acid is heated to 110° C. and 2.7 g of the polymer is added. The temperature is raised to 140° C. and held for 4 hours. After cooling down to 100° C. 8 ml of water is added dropwise and the mixture is allowed to cool. The resulting suspension is filtered, washed with concentrated hydrochloric acid and dried. Yield of the sulfonated polymer is ˜2 g.

### Example 8

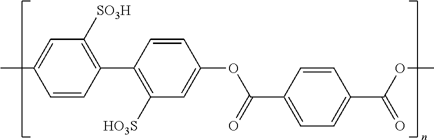

This example describes synthesis of poly(2,2′-disulfobiphenyl-dioxyterephthaloyl) (structure 7 in Table 1).

1.384 g (0.004 mol) of 4,4′-dihydroxybiphenyl-2,2′-disulfonic acid was mixed with 2.61 g (0.008 mol) of sodium carbonate and 40 ml of water in 500 ml beaker and stirred with dispersing stirrer until the solid completely dissolved. Dichloromethane (50 ml) was added to the solution. Upon stirring at high speed (7000 rpm) the solution of 0.812 g (0.004 mol) of terephthaloyl chloride in anhydrous dichloromethane (15 ml) was added. Stirring was continued for 30 minutes and 400 ml of acetone were added to the thickened reaction mass. Solid polymer was crushed with the stirrer and separated by filtration. The product was washed three times with 80% ethanol and dried at 50° C.

### Example 9

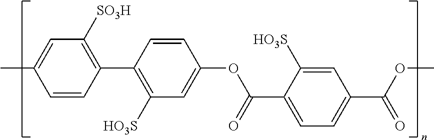

This example describes synthesis of poly(2,2′-disulfobiphenyl-2-sulfodioxyterephthaloyl) (structure 8 in Table 1).

1.384 g (0.004 mol) of 4,4′-dihydroxybiphenyl-2,2′-disulfonic acid was mixed with 3.26 g (0.010 mol) of sodium carbonate and 40 ml of water in a 500 ml beaker, and was stirred with dispersing stirrer until the solid was completely dissolved. Dichloromethane (60 ml) was added to the solution. Upon stirring at a high speed (7000 rpm) 1.132 g (0.004 mol) of 2-sulfoterephthaloyl chloride was added within 15 minutes. Stirring was continued for 3 hours and 400 ml of acetone was added to the thickened reaction mass. Precipitated polymer was separated by filtration and dried at 50° C.

### Example 10

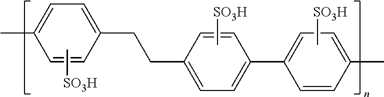

This example describes synthesis of poly(sulfophenylene-1,2-ethylene-2,2′-disulfobiphenylene) (structure 9 in Table 1).

36 g of a finely ground bibenzyl in a Petri dish is set on a porcelain rack in a desiccator with an evaporating dish under the rack containing 80 g of bromine. The desiccator is closed but a very small opening is provided for the escape of hydrogen bromide. The bibenzyl is left in contact with the bromine vapors for overnight. Then the dish with bromine is removed from the desiccator and the excess of bromine vapors are evacuated by water pump. The orange solid is then recrystallized from 450 ml of isopropyl alcohol. The yield of 4,4′-dibromobibenzyl is 20 g.

A solution of 23.6 g of 1,4-dibromobenzene in 90 ml of dry tetrahydrofuran is prepared. 10 ml of the solution is added with stirring to 5.0 g of magnesium chips and iodine (a few crystals) in 60 ml of dry tetrahydrofuran, and the mixture is heated until reaction starts. Boiling conditions are maintained by the gradual addition of the remained dibromobenzene solution. Then the reaction mixture is boiled for 8 hours and left overnight under argon at room temperature. The mixture is transferred through a hose to a dropping funnel by means of argon pressure and added to a solution of 24 ml of trimethylborate in 40 ml of dry tetrahydrofuran during 3 hours at −78-70° C. (a solid carbon dioxide/acetone bath) and vigorous stirring. The mixture is stirred for 2 hrs, then allowed to heat to room temperature with stirring overnight under argon. The mixture is diluted with 20 ml of ether and poured to a stirred mixture of crushed ice (200 g) and conc. H₂SO₄ (6 ml). To facilitate separation of the organic and aqueous layers 20 ml of ether and 125 ml of water are added and the mixture is filtered. The aqueous layer is extracted with ether (4×40 ml), the combined organic extracts are washed with 50 ml of water, dried over sodium sulfate and evaporated to dryness. The light brown solid is dissolved in 800 ml of chloroform and clarified.

The chloroform solution is evaporated almost to dryness, and the residual solid is recrystallized from benzene. A white slightly yellowish precipitate is filtered off and dried. The yield of dipropyleneglycol ester of benzyne 1,4-diboronic acid is 0.74 g.

The polymerization is carried out under nitrogen. 2.7 g of 4,4′-dibromo-2,2′-bibenzyl and 1.9 g of dipropyleneglycol ester of benzyne 1,4-diboronic acid are added to in a mixture of 2.8 g of sodium hydrocarbonate, 28.5 ml of tetrahydrofuran and 17 ml of water. Tetrakis(triphenylphosphine)palladium(0) is added (5×10⁻³ molar equivalent compared to dipropyleneglycol ester of benzyne 1,4-diboronic acid). The resulting suspension is stirred for 20 hrs. 0.04 g of Bromobenzene is then added. After an additional 2 hrs the polymer is precipitated by pouring it into 150 ml of ethanol. The product is washed with water, dried, and dissolved in toluene. The filtered solution is concentrated and the polymer precipitated in a 5-fold excess of ethanol and dried. The yield of polymer is 2.5 g.

8.8 g of 95% sulfuric acid is heated to 110° C., and 2.7 g of the polymer is added. The temperature is raised to 140° C. and held for 4 hours. After cooling down to the room temperature 8 ml of water is added dropwise and the mixture is allowed to cool. The resulting suspension is filtered, washed with concentrated hydrochloric acid and dried. Yield of the sulfonated polymer is 1.5 g.

### Example 11

This example describes synthesis of poly(2-sulfophenylene-1,2-ethylene-2′-sulfophenylene) (structure 10 in Table 1).

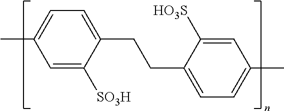

Polymerization is carried out under nitrogen. 10.2 g of 2,2′-[ethane-1,2-diylbis(4,1-phenylene)]bis-1,3,2-dioxaborinane, 10.5 g of 1,1′-ethane-1,2-diylbis(4-bromobenzene) and 1 g of tetrakis(triphenylphosphine)palladium(0) are mixed under nitrogen. Mixture of 50 ml of 2.4 M solution of potassium carbonate and 300 ml of tetrahydrofuran is degassed by nitrogen bubbling. Obtained solution is added to the first mixture. After that reaction mixture is agitated at ˜40° C. for 72 hours. The polymer is precipitated by pouring it into 150 ml of ethanol. The product is washed with water and dried. The yield of polymer is 8.7 g.

8.5 g of polymer is charged into 45 ml of 95% sulfuric acid. Reaction mass is agitated at ˜140° C. for 4 hours. After cooling down to the room temperature 74 ml of water is added dropwise and the mixture is allowed to cool. The resulting suspension is filtered, washed with concentrated hydrochloric acid and dried. Yield of the sulfonated polymer is 8 g.

### Example 12

This example describes synthesis of poly(2,2′-disulfobiphenyl-2-sulfo-1,4-dioxymethylphenylene) (structure 11 in Table 1).

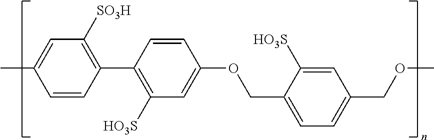

190 g of 4,4′-diaminobiphenyl-2,2′-disulfonic acid and 41.5 g of sodium hydroxide are dissolved in 1300 ml of water. 1180 g of ice is charged to this solution with stirring. Then 70.3 g of sodium nitrite, 230.0 ml of sulfuric acid and 1180 ml of water is added to the reaction mass and it is stirred for 1 hr at −2-0° C. Then it is filtered and washed with 2400 ml of icy water. The filter cake is suspended in 800 ml of water and heated to 100° C. Then the water is distilled out until about ˜600 ml of solution remained. 166 g of cesium hydroxide hydrate in 110 ml of water is added to the solution. Then it is added to 6000 ml of ethanol, the resulting suspension is stirred at room temperature, filtered and the filter cake washed with 600 ml of ethanol and dried in vacuum oven at 45° C. The yield of 4,4′-dihydroxybiphenyl-2,2′-disulfonic acid is 230 g.

30 ml of 96% sulfuric acid and 21 g of p-xylene are mixed, heated to 100° C. and kept at temperature for 15 min. The reaction mass is cooled to room temperature, quenched with 50 g water and ice. The resulting suspension is cooled to −10° C., filtered and the obtained filter cake washed with cold hydrochloric acid (15 ml of conc. acid and 10 ml of water). The precipitate is squeezed and recrystallized from hydrochloric acid solution (40 ml of conc. acid and 25 ml of water). The white substance is dried under vacuum at 90° C. The yield of p-xylene sulfonic acid is 34 g.

A mixture of 35 ml of carbon tetrachloride, 2.5 g of p-xylene sulfonic acid, 4.8 g of N-bromosuccinimide and 0.16 g of benzoyl peroxide is heated with agitation to boiling and held at temperature for 60 min. Then additional 0.16 g of benzoyl peroxide is added, and the mixture is kept boiling for additional 60 min. After cooling the product is extracted with 45 ml of water and recrystallized form 20% hydrochloric acid. The yield of 2,5-bis(bromomethyl)benzene sulfonic acid is approximately 1 g.

0.23 g of 4,4′-dihydroxybiphenyl-2,2′-disulfonic acid, 1.2 ml of o-dichlorobenzene, 0.22 g of 2,5-bis(bromomethyl)benzene sulfonic acid, 1.2 ml of 10N sodium hydroxide, and 0.081 g of tetrabutylammonium hydrogen sulfate are successfully added to a 25-ml flask equipped with a condenser and nitrogen inlet-outlet. The reaction mixture is stirred at 80° C. under nitrogen. After 6 hrs of reaction the organic layer is isolated and washed with water, followed by dilute hydrochloric acid, and again with water. Then the solution is added to methanol to precipitate white polymer. The polymer is then reprecipitated from acetone and methanol.

### Example 13

This example describes synthesis of a rigid rod-like macromolecule of the general structural formula 12 in Table 1, wherein R₁ is CH₃ and M is Cs.

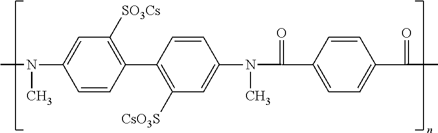

30 g 4,4′-diaminobiphenyl-2,2′-disulfonic acid is mixed with 300 ml pyridine. 60 ml of acetyl chloride is added to the mixture with stirring, and the resulting reaction mass is agitated for 2 hrs at 35-45° C. Then it is filtered, the filter cake is rinsed with 50 ml of pyridine and then washed with 1200 ml of ethanol. The obtained alcohol wet solid is dried at 60° C. Yield of 4,4′-bis(acetylamino)biphenyl-2,2′-disulfonic acid pyridinium salt is 95%.

12.6 g 4,4′-bis(acetylamino)biphenyl-2,2′-disulfonic acid pyridinium salt is mixed with 200 ml DMF. 3.4 g sodium hydride (60% dispersion in oil) is added. The reaction mass is agitated 16 hrs at room temperature. 7.6 ml methyl iodide is added and the reaction mass is stirred 16 hrs at room temperature. Then the volatile components of the reaction mixture are distilled off and the residue washed with 800 ml of acetone and dried. The obtained 4,4′-bis[acetyl(methyl)amino]biphenyl-2,2′-disulfonic acid is dissolved in 36 ml of 4M sodium hydroxide. 2 g activated charcoal is added to the solution and stirred at 80° C. for 2 hrs. The liquid is clarified by filtration, neutralized with 35% HCl to pH˜1 and reduced by evaporation to ˜30% by volume. Then it is refrigerated (5° C.) overnight and precipitated material isolated and dried. Yield of 4,4′-bis[methylamino]biphenyl-2,2′-disulfonic acid is 80%.

2.0 g 4,4′-bis[methylamino]biphenyl-2,2′-disulfonic acid and 4.2 g cesium hydrocarbonate are mixed with 6 ml water. This solution is stirred with IKA UltraTurrax T25 at 5000 rpm for 1 min. 2 ml triethylene glycol dimethyl ether is added, followed by 4.0 ml of toluene with stirring at 20000 rpm for 1 min. Then solution of 1.2 g terephtaloyl chloride in 2.0 ml of toluene is added to the mixture at 20000 rpm. The emulsion of polymer is stirred for 60 min and then poured into 150 ml of ethanol at 20000 rpm. After 20 min of agitation the suspension of polymer is filtered on a Buchner funnel with a fiber filter, the resulting polymer is dissolved in 8 ml of water, precipitated by pouring into of 50 ml of ethanol and dried for 12 hrs at 70° C. Yield is 2.3 g.

Analytical control of synthesis and purity of final product (4,4′-bis[methylamino]biphenyl-2,2′-disulfonic acid) was carried out by ion-pair HPLC. HPLC analysis of the intermediate products and final product was performed with Hewlett Packard 1050 (Agilent, USA) system comprising automated sample injector, quatpump, thermostated column compartment, diode array detector and ChemStation B10.03 software. Compounds were separated on a 15 cm×4.6 mm i.d., 5-μm particles, Dr. Maisch GmbH ReproSil—Pur Basic C18 column by use of a linear gradient prepared from acetonitrile (component A), water-solution of tetra-n-butylammonium bromide 0.01M (component B), and phosphate buffer 0.005M with pH=6.9-7.0 (component C). The gradient was: A-B-C 20:75:5 (v/v) to A-B-C 35:60:5 (v/v) in 20 min. The flow rate was 1.5 mL min⁻¹, the column temperature 30° C., and effluent was monitored by diode array detector at 230 and 300 nm.

### Example 14

This Example describes synthesis of natrium salt of the polymer shown by structure 17 in Table 1.

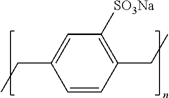

0.654 g of Copper (II) chloride (4.82 mmol, 0.07 eq) was dissolved into 410.0 ml (it was degassed by evacuated and filled with argon and further purging with argon) of water with stirring at ambient condition in 2500-ml beaker. 26.0 g of 2,5-bis-(bromomethyl)-benzenesulfonic acid (66.02 mmol) was added to the obtained solution and then 25.82 g of sodium bromide (250.88 mmol, 3.8 eq) was added into whitish suspension. 115.5 ml of n-amyl alcohol was added to a reaction mixture with a vigorous stirring. 10.03 g of sodium borohydride (264.08 mmol, 4.0 eq) in 52.0 ml of water was added in one portion to a reaction mixture with a vigorous stirring. The resulting mixture was stirred for 10 min. The bottom water layer was isolated and this dark foggy solution was filtered through a double layer glass filter paper (D=185 mm) The resulting solution was filtered through a filter-membrane (Millipore, PHWP29325, mixed cellulose ester, 0.3 mkm) with use of stirred ultrafiltration cell. Water was evaporated and 24.1 g of dry polymer was obtained. Mn=20536, Mw=130480, Pd=6.3.

### Example 15

This Example describes synthesis of natrium salt of the polymer shown with structure 20 in Table 1.

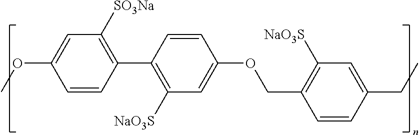

556 mg of 2,5-bis(bromomethyl)benzenesulfonic acid, 557 mg of 4,4′-dihydroxybiphenyl-2,2′-disulfonic acid and 500 mg of tetra-n-butylammonium bromide were dissolved in 10 ml of abs. N-methylpyrrolidone. 332 mg of 60% sodium hydride (5.1 eq.) was added by small portions to this solution and the mixture was stirred for 4 days at 50° C. After that, the mixture was poured into 100 ml of ethanol and filtered off. The precipitate was dissolved in water (˜5 ml) and precipitated into 100 ml of ethanol and filtered off again.

340 mg of polymer with Mn=9K, Mw=15K was obtained.

### Example 16

This Example describes synthesis of natrium salt of the polymer shown with structure 18 in Table 1.

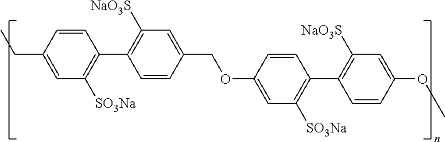

400 mg of 4,4′-bis(chloromethyl)biphenyl-2,2′-disulfonic acid, 337 mg of 4,4′-dihydroxybiphenyl-2,2′-disulfonic acid and 400 mg of tetra-n-butylammonium bromide were dissolved in 10 ml of abs. N-methylpyrrolidone. 238 mg of 60% sodium hydride (6.1 eq.) was added by small portions to this solution and the mixture was stirred for 4 days at 50° C. After that, the mixture was poured into 100 ml of ethanol and filtered off. The precipitate was dissolved in water (˜5 ml) and precipitated into 100 ml of ethanol and filtered off again.

330 mg of polymer with Mn=3K, Mw=5K was obtained.

Synthesis of Monomer for this Polymer was Done as Follows:

Intermediate 1:

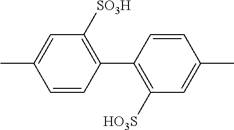

2-iodo-5-methylbenzenesulfonic acid (46 g, 137 mmol) was placed into a two-neck flask (volume 500 mL) and water (200 mL) was added. Blue copperas copper sulfate (0.25 g, 1 mmol) in water (40 mL) was added to a resultant solution and the mixture was then heated to 85° C. for 15 min. Copper powder was added (14 g, 227 mmol) to a resultant dark solution. Temperature was raised to 90° C., and then the reaction mixture was stirred for 3 h at 80-85°.

Reaction mixture was filtered twice, solution was concentrated to 75 mL on a rotary evaporator, cooled to 0° C. and ethanol was added dropwise (25 mL). The formed precipitate was filtered off, washed with ethanol and dried at 50° C. Yield is 28 g.

Intermediate 2:

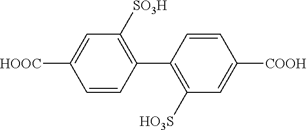

4,4′-dimethylbiphenyl-2,2′-disulfonic acid (30.0 g, 71.7 mmol) was dissolved in water (600 mL), and sodium hydroxide was added (12 g, 300 mmol). Resultant solution was heated to 45-50° C. and potassium permanganate was added (72 g, 45 mmol) in portions for 1 h 30 min. The resultant mixture was stirred for 16 h at 50-54° C. then cooled to 40° C., methanol was added (5 mL), temperature was raised to 70° C. Mixture was cooled to 40° C., filtered from manganese oxide, a clear colorless solution was concentrated to 100 mL acidified with hydrochloric acid (50 mL). The resultant mixture was left overnight, cooled to 0° C. and filtered off, washed with acetonitrile (100 mL, re-suspension) and diethylether, dried. Yield is 13.5 g fibrous white solid.

Intermediate 3:

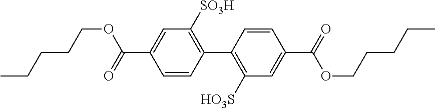

2,2′-disulfobiphenyl-4,4′-dicarboxylic acid (7.5 g, 18.6 mmol) was mixed with n-pentanol (85 mL, 68 g, 772 mmol) and sulfuric acid (0.5 mL) and heated under reflux with Dean-Stark trap for 3 h more. Reaction mixture was cooled to 50° C., diluted with hexane (150 mL), stirred at the same temperature for 10 min, precipitate was filtered off and washed with hexane (3×50 mL) and then dried at 50° C. for 4 h. Weight 8.56 g (84%) as a white solid.

Intermediate 4:

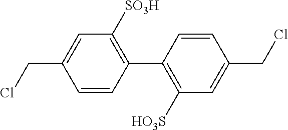

Anhydrous tetrahydrofuran (400 mL) was placed into a flask supplied with condenser, magnetic stirrer, thermometer and argon T-tube. Lithium alumohydride (3.5 g, 92 mmol) was added to tetrahydrofuran, the resultant suspension was heated to 50° C., and 4,4′-bis[(pentyloxy)carbonyl]biphenyl-2,2′-disulfonic acid was added in portions for 10 min with efficient stirring (20.0 g, 37 mmol). The resultant suspension was mildly boiled under reflux (63-64° C.) for 1.5 h.

Reaction mixture was cooled to 10° temperature (ice-water) and water was added with stirring until hydrogen evolution ceased (5-5.2 mL), mixture was diluted with anhydrous tetrahydrofuran (100 mL) to make stirring efficient. The resultant white suspension was transferred to a flask of 1 L volume, acidified with hydrochloric acid 36% (24 g). Sticky precipitate was formed. It was well-stirred with a glass rod, and the mixture was taken to dryness on a rotary evaporator, residue was mixed with anhydrous tetrahydrofuran (100 mL), solvent removed on a rotary evaporator, white solid residue was dried in a drying pistol at 67° C./10 mm Hg (boiling methanol) for 2 h. White pieces were powdered and dried for 1 h more

The resultant weight is 30 g, white powder. Calculated product content is approx 1.25 mmol/g (50%) of diol in the mixture of inorganic salts (AlCl₃, LiCl) and solvating water.

Crude 4,4′-bis(hydroxymethyl)biphenyl-2,2′-disulfonic acid (3.0 g, 3 mmol) was mixed with hydrochloric acid 36% (10 mL) and stirred at bath temperature of 85° C. for 1.5 h. Gas hydrogen chloride was passed though reaction mixture twice for 10 minutes after 15 minutes and 1 h 20 minutes of heating. Clear solution was not formed but almost clear suspension was observed. Reaction mixture was cooled to 0° with ice-water bath, stirred under a flow of hydrochloric acid at this temperature, and white precipitate was filtered off and dried over potassium hydroxide overnight in vacuo. Weight 2.6 g.

### Example 17

This Example describes synthesis of natrium salt of the polymer shown with structure 19 in Table 1.

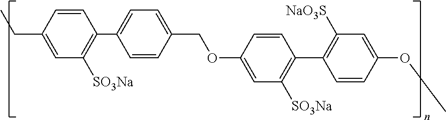

100 mg of 4,4′-bis(bromomethyl)biphenyl-2-sulfonic acid, 83 mg of 4,4′-dihydroxybiphenyl-2,2′-disulfonic acid and 80 mg of tetra-n-butylammonium bromide were dissolved in 2 ml of abs. N-methylpyrrolidone. 50 mg of 60% sodium hydride (5.1 eq.) was added by small portions to this solution, and the mixture was stirred for 4 days at 50° C. After that, the mixture was poured into 20 ml of ethanol and filtered off. The precipitate was dissolved in water (˜2-3 ml) and precipitated into 50 ml of ethanol and filtered off again.

100 mg of polymer with Mn=10K, Mw=23K was obtained.

Synthesis of Monomer for this Polymer was Done as Follows:

Intermediate 5:

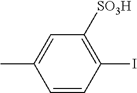

2-Sulfo-p-toluidine (50 g, 267 mmol) was mixed with water (100 mL) and hydrochloric acid 36% (100 mL). The mixture was stirred and cooled to 0° C. A solution of sodium nitrite (20 g, 289 mmol) in water (50 mL) was added slowly (dropping funnel, 1.25 h) keeping temperature at 3-5° C. Then the resultant suspension was stirred for 1 h 45 min at 0-3° C., filtration produced a dark mass which was added wet in portions into a tall beaker supplied with a magnetic stirrer and thermometer containing potassium iodide (66.5 g, 400 mmol) dissolved in 25% sulfuric acid (212 mL), temperature was kept around 10° C. during the addition. A lot of nitrogen was evolved, foaming; big magnetic bar is required. Then the reaction mixture was warmed to room temperature and 25% solution of sulfuric acid (200 mL) was added. Heating was continued at 70° C. for 30 min and 25% solution of sulfuric acid (150 mL) was added and stirred for a while. Mixture was hot filtered from black insoluble solids, cooled to room temperature with stirring. A precipitate was formed, solution was dark. Precipitate was filtered on a Pall glass sheet, washed with ethanol-water 1:1 (100 mL), re-suspended (ethanol 100 mL) and filtered once again, washed on the filter with ethanol (50 mL) and dried in a stove at 50° C., the resultant compound is pale-brown. Yield is 46 g (57%).

Intermediate 6:

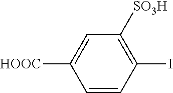

In one-neck flask (volume 1 L) water was placed (500 mL) followed by sodium hydroxide (6.5 g, 160 mmol) and 3-sulfo-4-iodotoluene (20.0 g, 67.1 mmol). The resultant solution was warmed up to 40° C. and finely powdered potassium permanganate (31.8 g, 201 mmol) was introduced in small portions at intervals of 10 min into a well stirred liquid. Addition was carried out for 1 h 30 min. Temperature was kept at 40-45° C. (bath) during the addition. Then the reaction mixture was heated up to 75-80° C. (bath) and left for 16 h at this temperature. A mixture of methanol-water 1:1 (5.5 mL) was added at 60° C., dark suspension was cooled to 35-40° C. and filtered off. Clear transparent solution was acidified with hydrochloric acid 36% (130 mL) and concentrated on a rotary evaporator distilling approx. ⅓ of the solvent. White precipitate was formed. Suspension was cooled on ice, filtered off, washed with acetonitrile (50 mL) and diethylether (50 mL). White solid was dried in a stove at 50° C. until smell of hydrochloric acid disappeared (4 h). Weight 22 g.

Intermediate 7:

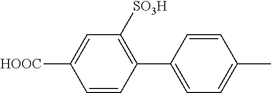

Water (550 mL) was placed into a flask equipped with thermometer, magnetic stirrer, argon inlet tube and bubble counter, heated to 40° C., potassium carbonate was added (40.2 g, 291 mmol), followed by 4-iodo-3-sulfobenzoic acid (19.1 g, 58.3 mmol) and 4-methylphenylboronic acid (8.33 g, 61.2 mmol). Solution was formed. Apparatus was evacuated and filled with argon 4 times with stirring. Pd/C 10% (Aldrich, 1.54 mg, 1.46 mmol) was added and apparatus was flashed with argon 3 more times. Temperature of solution was raised to 75-80° and resultant mixture (transparent except for C) was stirred for 16 h under argon atmosphere. Reaction mixture was cooled to 40° C., filtered twice (PALL), hydrochloric acid 36% was added drop wise (ice bath) until CO₂ evolution seized and a little bit more (55 g). Suspension resultant was cooled on ice, filtered off, washed in a beaker with acetonitrile (50 ml), filtered and washed with diethylether (50 mL) on the filter, then dried in a stove for 3 h at 45° C. Yield 10.0 g (58%).

Intermediate 8:

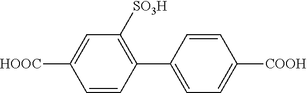

In two-neck flask (volume 0.5 L) water was placed (500 mL) followed by sodium hydroxide (4.4 g, 109 mmol) and 4′-methyl-2-sulfobiphenyl-4-carboxylic acid (10.0 g, 34.2 mmol). Resultant solution was warmed up to 40° C. (oil bath, inner temperature) and finely powdered potassium permanganate (16.2 g, 102.6 mmol) was introduced in small portions at intervals of 10 min into well stirred liquid. Addition was carried out for 45 min. Temperature was kept at 40-45° C. (bath) during addition. Then reaction mixture was heated up to 50° C. (inner) and left for 18 h at this temperature with stirring. A mixture of methanol-water 1:1 (2 mL) was added at 45° C., dark suspension was cooled to r.t. and filtered off. Clear transparent solution was acidified with hydrochloric acid 36% (13 g). White precipitate formed. Suspension was cooled on ice, filtered off, washed with acetonitrile (50 mL) in a beaker, filtered and washed with diethylether (50 mL) on the filter. White solid was dried in a stove at 50° C. until smell of hydrochloric acid disappeared (4 h). Weight 7.5 g (68%)

Intermediate 9:

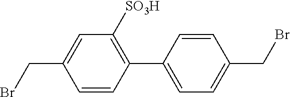

Powdered 2-sulfobiphenyl-4,4′-dicarboxylic acid (7.5 g, 23.3 mmol) was mixed with anhydrous (dist. over magnesium) methanol (100 mL) and sulfuric acid (d 1.84, 2.22 mL, 4.0 g, 42.6 mmol). Resultant suspension was left with stirring and mild boiling for 2 days. Sodium carbonate (5.01 g, 47.7 mmol) was added to methanol solution and stirred for 45 min then evaporated on a rotary evaportator. Residue (white powder) was mixed with tetrahydrofuran to remove any big particles (100 mL) and resultant suspension was dried on a rotary evaporator, then in a desiccator over phosphorus oxide under reduced pressure overnight. Resultant residue was used in further transformation as it is.

A one-neck flask (volume 250 mL) containing dried crude 4,4′-bis(methoxycarbonyl)biphenyl-2-sulfonic acid and magnetic stirrer and closed with a stopper was filled with tetrahydrofuran (anhydrous over sodium, 150 mL). White suspension was stirred for 20 min at r.t. to insure its smoothness then lithium alumohydride was added in portions (0.2-0.3 g) for 40 min. Exothermic effect was observed. Temperature was raised to 45-50° C. Then joints were cleaned with soft tissue and flask was equipped with condenser and argon bubble T-counter. Resultant suspension was heated with stirring (bath 74° C.) for 3 h.
Reaction mixture was cooled to 10° C. on ice, and water was added drop wise until hydrogen evolution (handle with caution) seized (4 mL). Hydrobromic acid (48%) was added in small portions until suspension became milky (43 g, acid reaction of indicator paper). The suspension was transferred to flask of 0.5 L volume and it was taken to almost to dryness on a rotary evaporator. Hydrobromic acid 48% was added to the flask (160 mL), resultant muddy solution was filtered (PALL) and flask was equipped with h-tube with a thermometer and argon inlet tube. Apparatus was flashed with argon and placed on an oil bath. Stirring was carried out while temperature (inner) was raised to 75° C. for 15 min. After 7 minutes at this temperature formation of white precipitate was observed. Stirring was carried out for 1.5 h at 70-75° C., then suspension was cooled to 30° C., filtered off, precipitate was washed with cold hydrobromic acid 48% (30 mL) on the filter, and pressed to some extent. Filter cake was dried over sodium hydroxide in a desiccator under reduced pressure with periodically filling it with argon. Weight 7.0 g (72% on diacid).

### Example 18

This Example describes synthesis of 7-(4-sulfophenyl)dibenzo[b,d]thiophene-3-sulfonic acid 5,5-dioxide (structure 43 in Table 3).

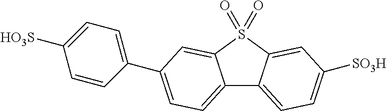

7.83 g of p-Terphenyl was dissolved in 55 ml of 10% oleum at 10-20° C., and the mixture was stirred for 20 hrs at ambient temperature. 20 g of ice was added to this formed suspension and the mixture was cooled to 0° C. The solid was filtered and washed with 36% hydrochloric acid, dissolved in min amount of water (the solution was filtered from impurities) and precipitated with 36% hydrochloric acid. The product was filtered, washed with 36% hydrochloric acid and dried. It was obtained 9.23 g.

### Example 19

This example describes preparation of the polycyclic organic compound of structure 35 from Table 3

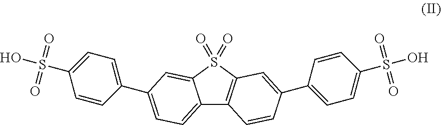

4,4′-(5,5-Dioxidodibenzo[b,d]thiene-3,7-diyl)dibenzenesulfonic acid (structure 25) was prepared by sulfonation of 1,1′:4′,1″:4″,1′″-quaterphenyl. 1,1′:4′,1″:4″,1′″-Quaterphenyl (10 g) was charged into 20% oleum (100 ml). Reaction mass was agitated for 5 hours at ambient conditions. After that the reaction mixture was diluted with water (170 ml). The final sulfuric acid concentration became ˜55%. The precipitate was filtered and rinsed with glacial acetic acid (˜200 ml). Filter cake was dried in oven at ˜110° C. The process yielded 8 g of 4,4′-(5,5-dioxidodibenzo[b,d]thiene-3,7-diyl)dibenzenesulfonic acid.

The product was analyzed with ¹H NMR (Brucker Advance-600, DMSO-d₆, δ, ppm) and showed the following results: 7.735 (d, 4H, 4CH^{Ar}(3,3′,5,5′)); 7.845 (d, 4H, 4CH^{Ar}(2,2′,6,6′)); 8.165 (dd, 2H, 2CH^{Ar}(2,8)); 8.34 (m, 4H, 4CH^{Ar}(1,9,4,6)). The electronic absorption spectrum of the product measured in an aqueous solution with Spectrometer UV/VIS Varian Cary 500 Scan showed the absorption maxima at λₘₐₓ₁=218 nm (ε=3.42*10⁴), λₘₐₓ₂=259 nm (ε=3.89*10⁴), and λₘₐₓ₃=314 nm (ε=4.20*10⁴). The mass spectrum of the product recorded using a Brucker Daltonics Ultraflex TOF/TOF is as follows: molecular ion (M⁻=529), FW=528.57.

While certain preferred embodiments of the invention have been specifically disclosed, it should be understood that the invention is not limited thereto as many variations will be readily apparent to those skilled in the art and the invention is to be given its broadest possible interpretation within the terms of the following claims.

What is claimed is:

1. A patterned retarder comprising
at least one retardation plate comprising
a substrate substantially transparent in visible spectral range and having front and rear surfaces, and
a set of parallel stripes located on the front surface of the substrate, wherein the stripes possess in-plane retardation.

2. A patterned retarder according to claim 1, wherein the stripes possess retardation properties selected from the list comprising B_{A}-type, positive A, negative A, and Ac-type retardation.

3. A patterned retarder according to claim 2, wherein the fast optical axis corresponding to the principal refractive index nₓ is parallel to the direction of the stripes.

4. A patterned retarder according to claim 2, wherein the fast optical axis corresponding to the principal refractive index nₓ is directed perpendicularly to the direction of the stripes.

5. A patterned retarder according to claim 2, wherein the fast optical axis corresponding to the principal refractive index nₓ is directed at 45 degrees to the direction of the stripes.

6. A patterned retarder according to any of claims 1 or 2, wherein the stripes further comprise at least one organic compound of a first type or its salt, wherein the organic compound of the first type has the general structural formula I 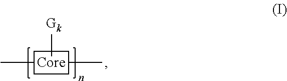
where Core is a conjugated organic unit capable of forming a rigid rod-like macromolecule,
n is a number of the conjugated organic units in the rigid rod-like macromolecule which is equal to integers in the range from 10 to 10000, Gₖ is a set of ionogenic side-groups, and k is a number of the side-groups in the set Gₖ, k is a number of the side-groups in the set Gₖ₁ which is equal to 0, 1, 2, 3, 4, 5, 6, 7, or 8;
and/or at least one organic compound of a second type, wherein the organic compound of the second type has the general structural formula II 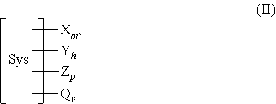
where Sys is an at least partially conjugated substantially planar polycyclic molecular system; X, Y, Z, Q and R are substituents; substituent X is a carboxylic group —COOH, m is 0, 1, 2, 3 or 4; substituent Y is a sulfonic group —SO₃H, h is 0, 1, 2, 3 or 4; substituent Z is a carboxamide —CONH₂, p is 0, 1, 2, 3 or 4; substituent Q is a sulfonamide —SO₂NH₂, v is 0, 1, 2, 3 or 4;
wherein the organic compound of the second type forms board-like supramolecules via π-π-interaction, and
a composition comprising the compounds of the first and the second types forms lyotropic liquid crystal in a solution with a suitable solvent.

7. A patterned retarder according to claim 6, wherein the organic compound of the first type is selected from the list comprising structures 1 to 20: 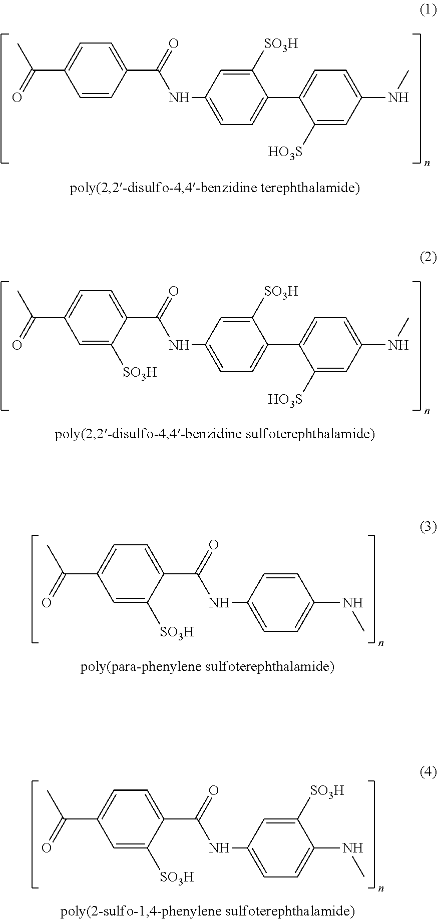 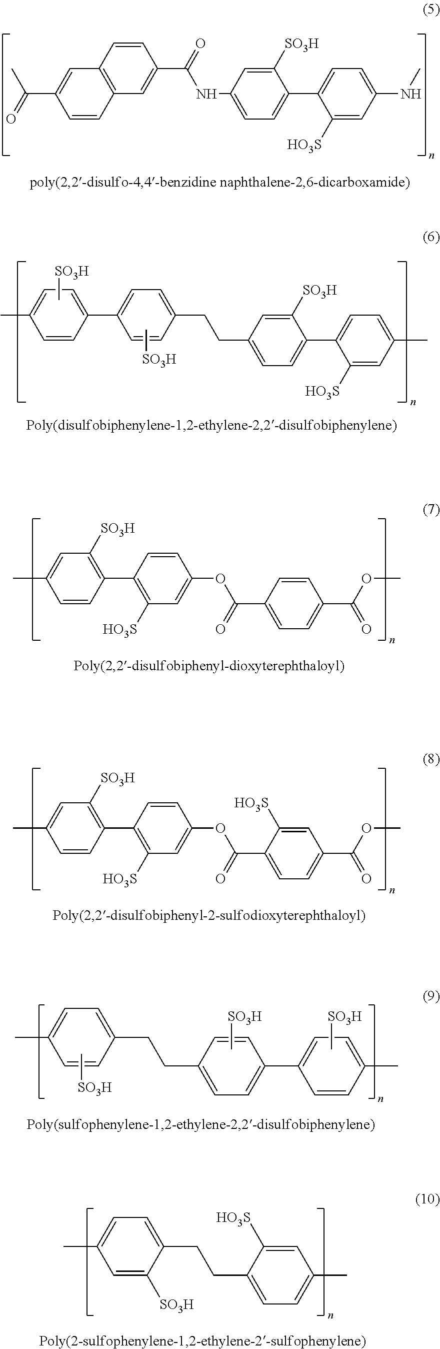 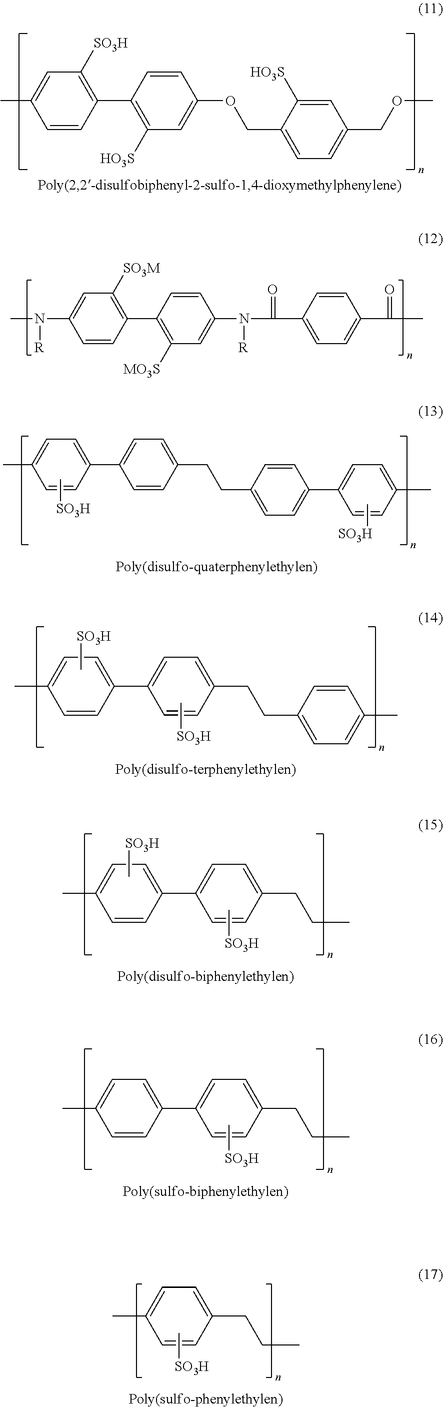 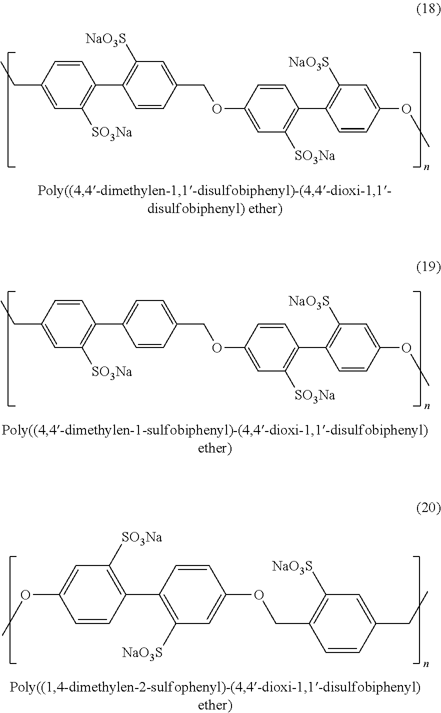
where R is a side-group selected from the list comprising Alkil, (CH₂)ₘSO₃H, (CH₂)ₘSi(O Alkyl)₃, CH₂Phenyl, (CH₂)ₘOH and M is counterion selected from the list comprising H⁺, Na⁺, K⁺, Li⁺, Cs⁺, Ba²⁺, Ca²⁺, Mg²⁺, Sr²⁺, Pb²⁺, Zn²⁺, La³⁺, Ce³⁺, Y³⁺, Yb³⁺, Gd³⁺, Zr⁴⁺ and NH₄₋ₖQₖ⁺, where Q is selected from the list comprising linear and branched (C1-C20) alkyl, (C2-C20) alkenyl, (C2-C20) alkinyl, and (C6-C20)arylalkyl, and k is 0, 1, 2, 3 or 4.

8. A patterned retarder according to claim 6, wherein the organic compound of the first type further comprises additional side-groups independently selected from the list comprising linear and branched (C₁-C₂₀)alkyl, (C₂-C₂₀)alkenyl, and (C₂-C₂₀)alkinyl.

9. A patterned retarder according to claim 8, wherein at least one of the additional side-groups is connected with the conjugated organic unit Core via a bridging group A selected from the list comprising —C(O)—, —C(O)O—, —C(O)—NH—, —(SO₂)NH—, —O—, —CH₂O—, —NH—, >N—, and any combination thereof.

10. A patterned retarder according to claim 6, wherein the salt of the organic compound of the first type is selected from the list comprising ammonium and alkali-metal salts.

11. A patterned retarder according to claim 6, wherein the organic compound of the second type has at least partially conjugated substantially planar polycyclic molecular system Sys selected from the list of the structures of the general structural formulas 21 to 34:

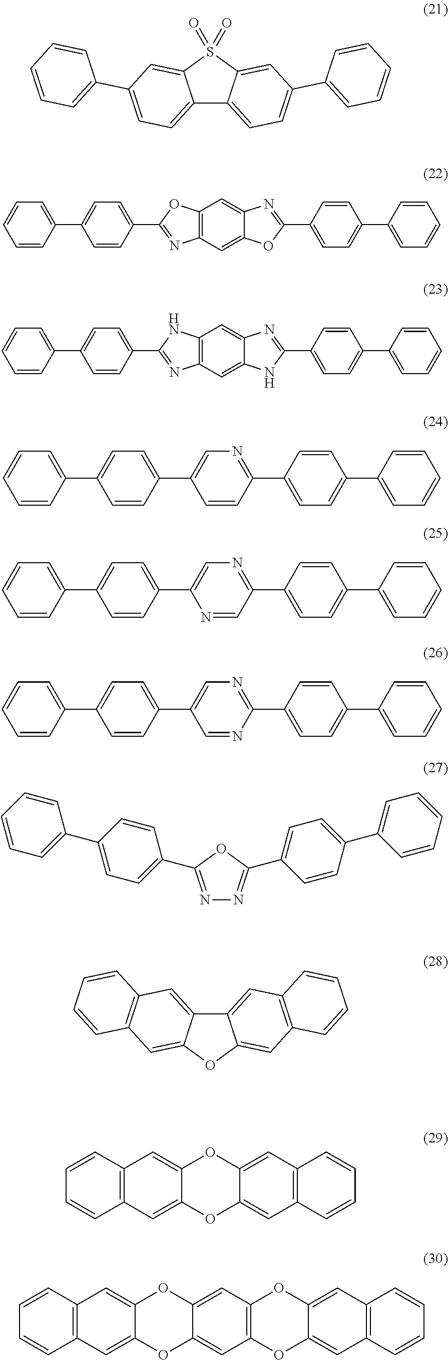

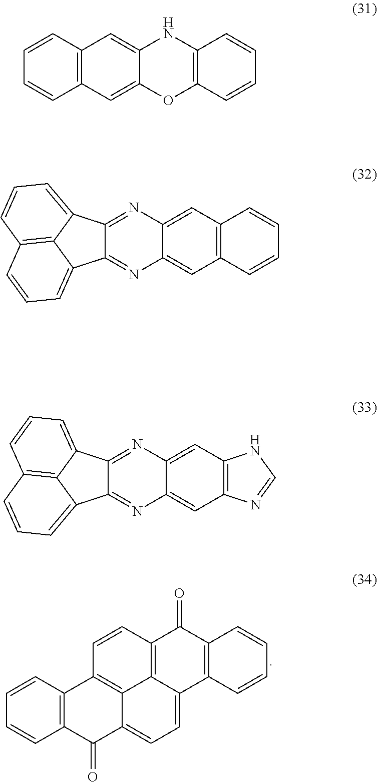

12. A patterned retarder according to claim 11, wherein the organic compound of the second type is selected from the list of the structures 35 to 43, where the molecular system Sys is selected from the list of the structures 21 and 28 to 34, the substituent is a sulfonic group —SO₃H, and m1, p1, and v1 are equal to 0:

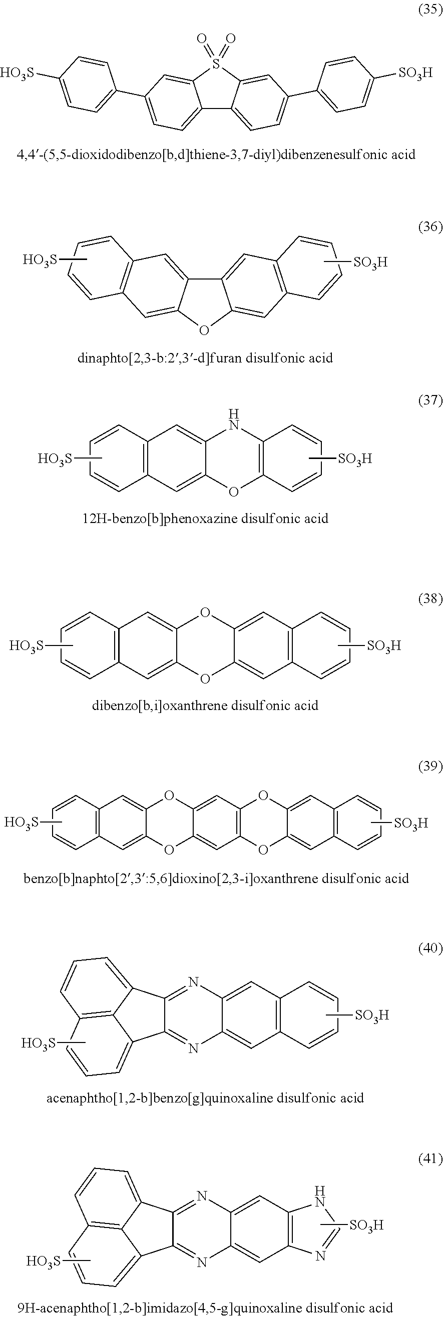

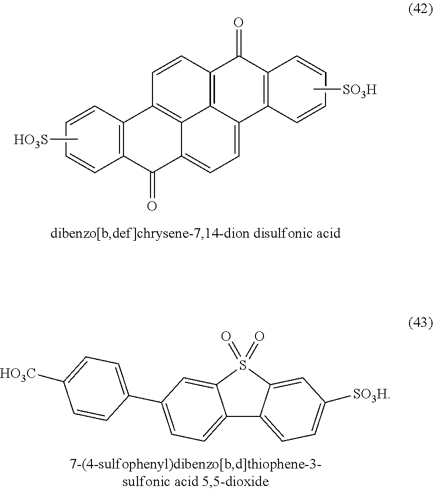

13. A patterned retarder according to claim 6, wherein the organic compound of the second type further comprises at least one substituent selected from the list comprising CH₃, C₂H₅, Cl, Br, NO₂, F, CF₃, CN, OH, OCH₃, OC₂H₅, OCOCH₃, OCN, SCN, and NHCOCH₃.

14. A patterned retarder according to claim 1, wherein the substrate is made of polymer.

15. A patterned retarder according to claim 1, wherein the substrate is made of glass.

16. A patterned retarder according to claim 1, wherein the substrate is made of a birefringent material and possesses an anisotropic property of a positive A-type retarder.

17. A patterned retarder according to claim 16, wherein the birefringent material is selected from the list comprising poly ethylene terephtalate (PET), poly ethylene naphtalate (PEN), polyvinyl chloride (PVC), polycarbonate (PC), poly propylene (PP), poly ethylene (PE), polyimide (PI), and poly ester.

18. A patterned retarder according to claim 1, further comprising a planarization layer located on top of the set of the stripes.

19. A patterned retarder according to claim 1, further comprising an additional transparent adhesive layer.

20. A patterned retarder according to claim 1, further comprising a retardation panel.

21. A patterned retarder according to claim 20, wherein the retardation panel comprises a panel substrate substantially transparent in the visible spectral range and having front and rear surfaces and a panel retardation layer located on the front surface of the panel substrate, wherein the retardation plate is located on the panel retardation layer so that the front surface of the panel substrate is facing the front surface of the substrate of the retardation plate.

22. A patterned retarder according to claim 21, wherein the panel retardation layer further comprising at least one organic compound of a first type or its salt, wherein the organic compound of the first type has the general structural formula I 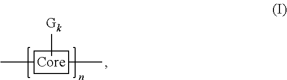
where Core is a conjugated organic unit capable of forming a rigid rod-like macromolecule,
n is a number of the conjugated organic units in the rigid rod-like macromolecule which is equal to integers in the range from 10 to 10000, Gₖ is a set of ionogenic side-groups, and k is a number of the side-groups in the set Gₖ, k is a number of the side-groups in the set Gₖ₁ which is equal to 0, 1, 2, 3, 4, 5, 6, 7, or 8;
and/or at least one organic compound of a second type, wherein the organic compound of the second type has the general structural formula II 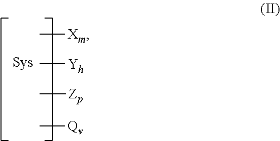
where Sys is an at least partially conjugated substantially planar polycyclic molecular system; X, Y, Z, Q and R are substituents; substituent X is a carboxylic group —COOH, m is 0, 1, 2, 3 or 4; substituent Y is a sulfonic group —SO₃H, h is 0, 1, 2, 3 or 4; substituent Z is a carboxamide —CONH₂, p is 0, 1, 2, 3 or 4; substituent Q is a sulfonamide —SO₂NH₂, v is 0, 1, 2, 3 or 4;
wherein the organic compound of the second type forms board-like supramolecules via π-π-interaction, and a composition comprising the compounds of the first and the second types forms lyotropic liquid crystal in a solution with a suitable solvent.

23. A patterned retarder according to claim 20, wherein the stripes of the retardation plate possess in-plane retardation equal to λ/2 and the retardation panel possesses in-plane retardation equal to λ/4, where λ is central wave-length of a working wave-band.

24. A patterned retarder according to claim 1, comprising two retardation plates, wherein the first retardation plate comprises a first substrate having a front surface and a rear surface and the second retardation plate comprises a second substrate having a front surface and a rear surface, wherein the first retardation plate comprises a first set of parallel stripes located on the front surface of the first substrate and the second retardation plate comprises a second set of parallel stripes located on the front surface of the second substrate, wherein the first retardation plate is located on the second retardation plate so that the front surface of the first substrate is facing the front surface of the second substrate and wherein the stripes of the first set are located between the stripes of the second set and the stripes of both sets are mostly parallel to each other.

25. A patterned retarder according to claim 24, wherein the in-plane retardation of the stripes of the first retardation plate and the in-plane retardation of the stripes of the second retardation plate are equal to λ/4, where λ is central wave-length of a working wave-band, wherein the fast optical axis of the first retardation plate is directed perpendicularly with respect to the fast optical axis of the second retardation plate, and wherein the optical axes are located in the plane of the stripes.

26. A patterned retarder according to claim 25, wherein the in-plane retardation of the stripes of the first retardation plate is equals to λ/4 and the in-plane retardation of the stripes of the second retardation plate is equals to 3λ/4, where λ is central wave-length of a working wave-band.

27. A method of producing a patterned retardation plate, comprising the steps of
a) preparation of a lyotropic liquid crystal solution of a composition comprising
at least one organic compound of a first type, and/or
at least one organic compound of a second type,
wherein the organic compound of the first type has the general structural formula I 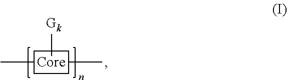
where Core is a conjugated organic unit capable of forming a rigid rod-like macromolecule,
n is a number of the conjugated organic units in the rigid rod-like macromolecule,
Gk is a set of ionogenic side-groups, and
k is a number of the side-groups in the set Gk;
wherein the ionogenic side-groups and the number k provide solubility of the organic compound of the first type in a solvent and give rigidity to the rod-like macromolecule; the number n provides molecule anisotropy that promotes self-assembling of macromolecules in a solution of the organic compound or its salt, and
wherein the organic compound of the second type has the general structural formula II 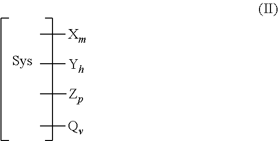
where Sys is an at least partially conjugated substantially planar polycyclic molecular system;
X, Y, Z, Q and R are substituents;
substituent X is a carboxylic group —COOH, m is 0, 1, 2, 3 or 4;
substituent Y is a sulfonic group —SO₃H, h is 0, 1, 2, 3 or 4;
substituent Z is a carboxamide —CONH₂, p is 0, 1, 2, 3 or 4;
substituent Q is a sulfonamide SO₂NH₂, v is 0, 1, 2, 3 or 4;
wherein the organic compound of the second type is capable of forming board-like supramolecules via π-π-interaction,
b) coating of a liquid layer of the solution onto a substrate,
c) application of an external alignment action onto said liquid layer,
d) drying to form a solid optical retardation layer, and
e) forming of a set of parallel retardation stripes on the substrate.

28. A method according to claim 27, wherein the forming of the set of parallel stripes is carried out by different methods selected from the list comprising skiving, plasma-assisted etching and laser ablation method.

29. A method according to claim 27, further comprising a post-treatment step comprising a treatment with a solution of any inorganic salt with a cation selected from the list comprising H⁺, Ba²⁺, Pb²⁺, Ca²⁺, Mg²⁺, Sr²⁺, La³⁺, Zn²⁺, Zr⁴⁺, Ce³⁺, Y³⁺, Yb³⁺, Gd³⁺ and any combination thereof soluble in water or any solvent mixable with water.

30. A method according to claim 27, wherein the application of an external alignment action c) and the forming of the set of parallel retardation stripes e) are carried out simultaneously.

31. A method according to claim 27, wherein the drying d) and the forming of the set of parallel retardation stripes e) are carried out sequentially.

32. A method according to claim 27, wherein the direction of the stripes in relation to the coating direction is selected from the list comprising parallel, perpendicular and at 45 degrees.

33. A method according to claim 27, wherein the organic compound of the first type is selected from the list of the structures 1 to 20: 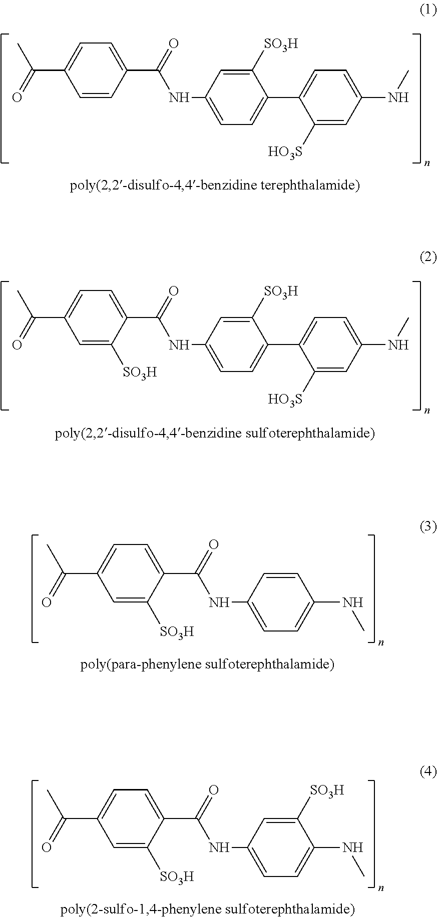 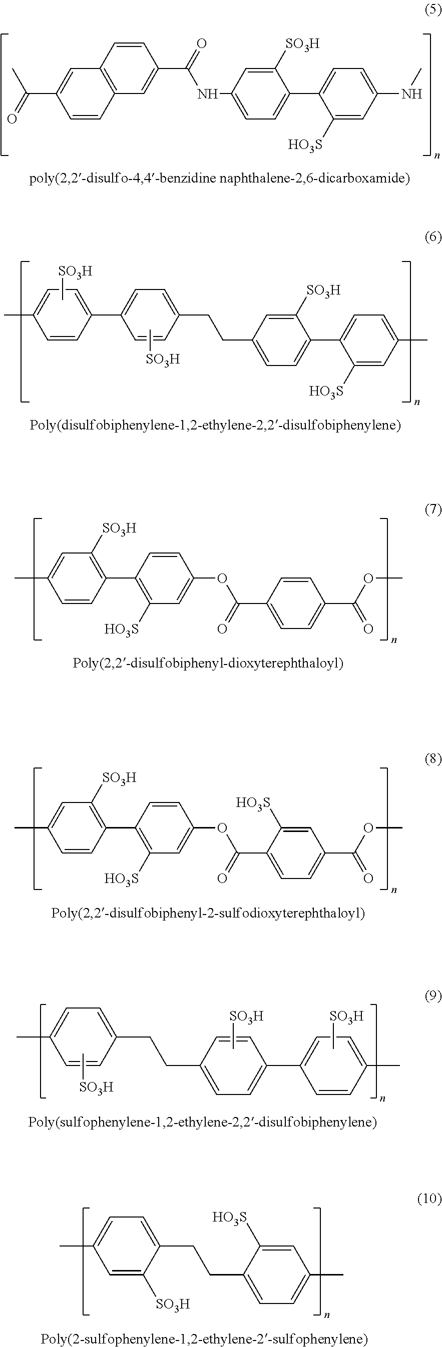 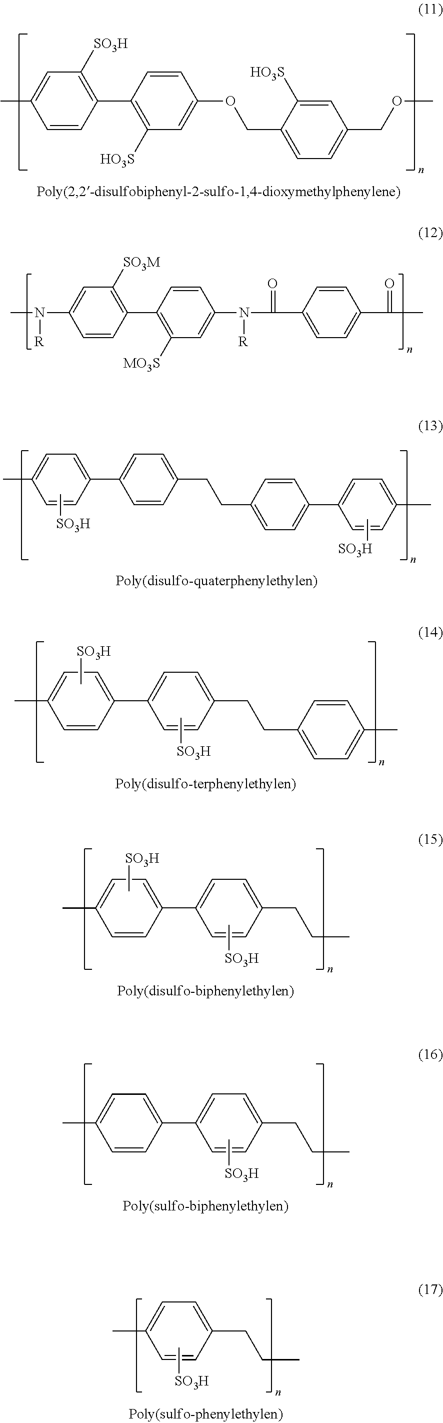 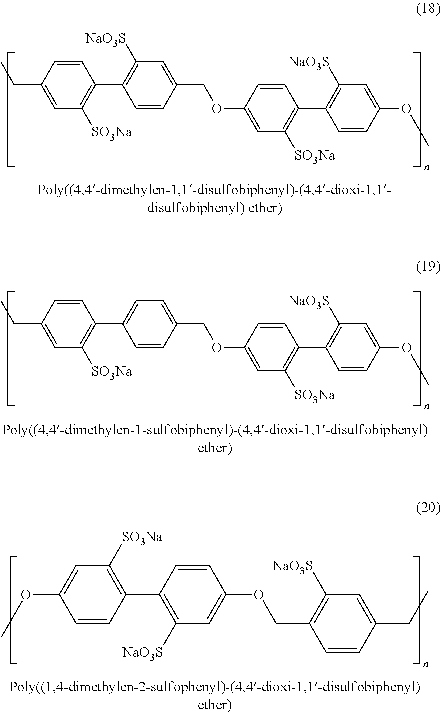
where R is a side-group selected from the list comprising Alkil, (CH₂)ₘSO₃H, (CH₂)ₘSi(O Alkyl)₃, CH₂Phenyl, (CH₂)ₘOH and M is counterion selected from the list comprising H⁺, Na⁺, K⁺, Li⁺, Cs⁺, Ba²⁺, Ca²⁺, Mg²⁺, Sr²⁺, Pb²⁺, Zn²⁺, La³⁺, Ce³⁺, Y³⁺, Yb³⁺, Gd³⁺, Zr⁴⁺ and NH₄₋ₖQₖ⁺, where Q is selected from the list comprising linear and branched (C1-C20) alkyl, (C2-C20) alkenyl, (C2-C20) alkinyl, and (C6-C20)arylalkyl, and k is 0, 1, 2, 3 or 4

34. A method according to claim 27, wherein the organic compound of the first type further comprises additional side-groups independently selected from the list comprising linear and branched (C₁-C₂₀)alkyl, (C₂-C₂₀)alkenyl, and (C₂-C₂₀)alkinyl.

35. A method according to claim 34, wherein at least one of the additional side-groups is connected with the conjugated organic unit Core via a bridging group A selected from the list comprising —C(O)—, —C(O)O—, —C(O)—NH—, —(SO₂)NH—, —O—, —CH₂O—, —NH—, >N—, and any combination thereof.

36. A method according to claim 27, wherein the salt of the organic compound of the first type is selected from the list comprising ammonium and alkali-metal salts.

37. A method according to claim 27, wherein the organic compound of the second type has at least partially conjugated substantially planar polycyclic molecular system Sys selected from the list of the structures of general structural formulas 21 to 34:

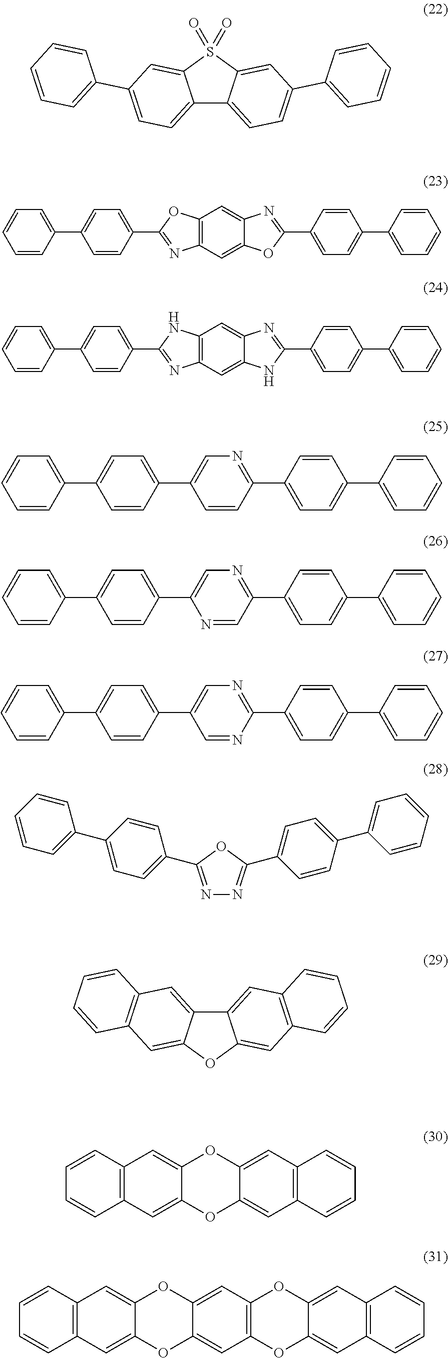

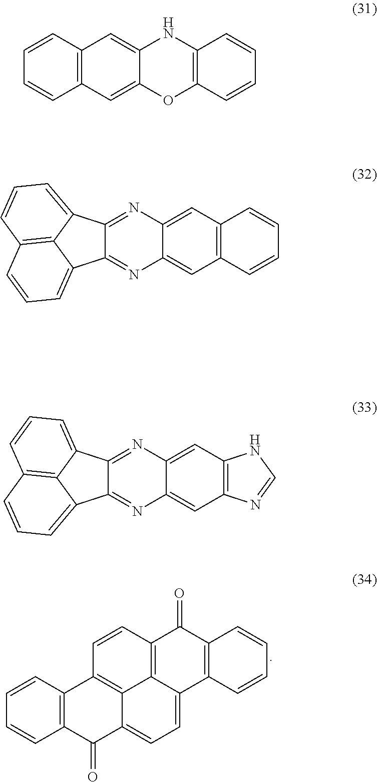

38. A method according to claim 37, wherein the organic compound of the second type is selected from the list of the structures 35 to 43, where the molecular system Sys is selected from the list of the structures 21 and 28 to 34, the substituent is a sulfonic group —SO₃H, and m1, p1, and v1 are equal to 0:

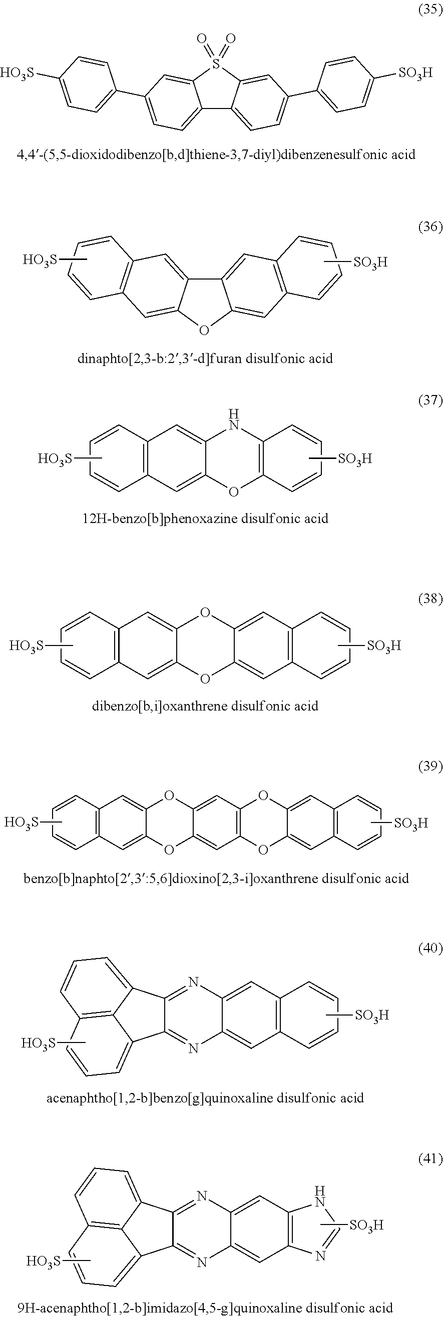

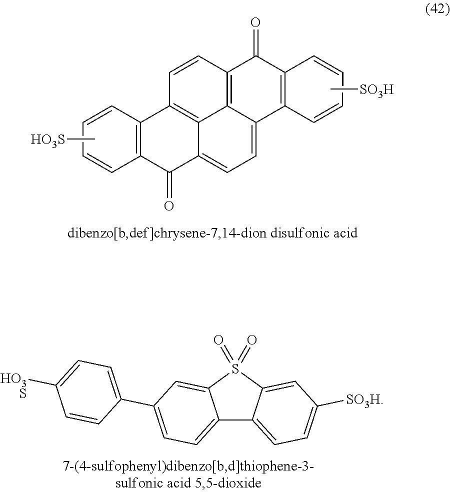

39. A method according to claim 27, wherein the organic compound of the second type further comprises at least one substituent selected from the list comprising CH₃, C₂H₅, Cl, Br, NO₂, F, CF₃, CN, OH, OCH₃, OC₂H₅, OCOCH₃, OCN, SCN, and NHCOCH₃.

40. A method according to claim 27, wherein the stripes possess retardation selected from B_{A}-type retardation and negative A-type retardation, characterized by two principal refractive indices (nₓ and n_{y}) corresponding to two mutually perpendicular directions in the plane of the stripes and one principal refractive index (n_{z}) in the normal direction to the stripes, which satisfy the following condition: nₓ<n_{z}<n_{y}.

41. A method according to claim 27, wherein the stripes possess negative A-type retardation and characterized by two principal refractive indices (nₓ and n_{y}) corresponding to two mutually perpendicular directions in the plane of the retardation layer and one principal refractive index (n_{z}) in the normal direction to the retardation layer, which satisfy the following condition: nₓ<n_{y}=n_{z}.

42. A method according to any of claims 40 or 41, wherein the fast optical axis corresponding to the principal refractive index nₓ coincides with the coating direction.

43. A method according to claim 27, wherein the stripes possess Ac-type retardation and characterized by two principal refractive indices (nₓ and n_{y}) corresponding to two mutually perpendicular directions in the plane of the stripes and one principal refractive index (n_{z}) in the normal direction to the stripes, which satisfy the following condition: n_{z}<n_{y}<nₓ.

44. A method according to claim 27, wherein the stripes possess positive A-type retardation and characterized by two principal refractive indices (nₓ and n_{y}) corresponding to two mutually perpendicular directions in the plane of the retardation layer and one principal refractive index (n_{z}) in the normal direction to the retardation layer, which satisfy the following condition: nₓ>n_{y}=n_{z}.

45. A method according to any of claims 43 or 44, wherein the slow optical axis corresponding to the principal refractive index nₓ coincides with the coating direction.
